(19) United States
(12) Patent Application Publication
(10) Pub. No.: US 2026/0091334 A1
(43) Pub. Date: Apr. 2, 2026

(54) AIR FLOW SEPARATION ELEMENT

(71) Applicant: NEUFILTER GMBH, Gronau (DE)

(72) Inventors: Florian HERLINGER, Gronau (DE); Thomas BÖING, Gronau (DE); Daniel HENKE, Gronau (DE)

(21) Appl. No.: 19/120,783

(22) PCT Filed: Oct. 11, 2023
(86) PCT No.: PCT/EP2023/078253

§ 371 Date: Apr. 13, 2025

(30) Foreign Application Priority Data
Oct. 18, 2022 (DE) 20 2022 105 864.4

(51) Int. Cl. B01D 45/08; B05B 14/44

(52) U.S. Cl. CPC B01D 45/08; B05B 14/44

(57) ABSTRACT

The invention relates to an air flow separation element, referred to in short as separation element (10), which is provided in a separation apparatus (60) or for use together with a separation apparatus for separating particles carried along in a raw gas flow.

### BACKGROUND OF THE INVENTION

### 1. Field of the Invention

### Description

The innovation proposed herein relates to the technical field of separating particles carried along in an air flow (raw gas flow), in particular the separation of paint or varnish particles carried along in a so-called paint mist as raw gas flow, i.e. the technical field of paint mist separation.

### 2. Description of Related Art

Apparatuses for this purpose, specifically air flow separation apparatuses (in short: separation apparatuses) are already known, for example in the form of the separation apparatus described in EP 2 532 409 B and referred to therein as filter module or in the form of the separation apparatus described in DE 10 2014 003 608 A1 and also referred to therein as a filter module.

One object of the proposed innovation is to provide a new form of air flow separation element which is intended for use with or in an air flow separation apparatus, in any case for separating particles carried along in a raw gas flow.

Air flow separation elements are also already known. These are flat elements that either have their own frame-like edge or are provided with a frame-like edge and are combined with other air flow separation elements and/or an air flow separation apparatus by means of said edge. An air flow separation element has a plurality of openings (holes) for the passage of the raw gas flow. A respective arrangement and a number of holes result in/determine a hole pattern of the respective air flow separation element.

EP 2 722 092 A1 discloses air filters in which filter media are inserted into a frame. A filter structure body for a filter module is known from EP 3 325 128 A1, which comprises a support structure divided into segments and a filter layer arranged thereupon. U.S. Pat. Nos. 4,561,587 and 7,537,632 disclose frames adapted to hold an air filter with closable corners, which are created by folding an initially flat, one-piece cardboard element. US 2009/0183477 A1 discloses frames with laterally protruding segments for air filters, wherein the segments allow several frames to be stacked and cause the frames to be adjusted relative to one another within the stack. CN 113842715 B discloses air flow separation elements that can be combined with each other in groups by means of comb-like connecting pieces, so that the air flow separation elements are arranged parallel to each other in a staggered arrangement one behind the other. CN 209985061 U discloses a single air flow separation element that can be placed in front of an air flow separation apparatus with its own frame. CN 216149343 U discloses air flow separation elements that can be placed together and in a staggered arrangement one behind the other in a common frame. DE 20 2022 102 215.1, which has not yet been published, describes an air flow separation element and an air flow separation apparatus formed therewith.

The object outlined above is achieved in accordance with the invention by means of an apparatus referred to here and hereinafter as an air flow separation element and sometimes simply as a separation element, having the features of claim 1.

Accordingly, the air flow separation element is intended and configured for separating particles carried along in a raw gas flow: A possible alternative long form for the designation of the air flow separation element is raw gas flow particle separation element/air particle separation element or—in the case of separation of particles due to paint mist—paint mist separation element. However, in the interest of better readability of the description presented herein, the short form “separation element” is often used in the following, wherein the term air flow separation element and the above long forms should also be read whenever this term is mentioned. The same applies accordingly to terms introduced further down, specifically separation combination (possible long forms: air flow separation combination: raw gas flow/air particle separation combination or paint mist separation combination) or separation apparatus (possible long forms: air flow separation apparatus: raw gas flow/air particle separation apparatus or paint mist separation apparatus).

The separation element (air flow separation element) has a separation area (air flow separation area), insertion areas, and connecting means adjoining the separation area or extending from the separation area, referred to as connecting flaps or flaps for short. Connecting flaps adjoining the separation area are integrally connected to the separation area, for example.

Connecting flaps extending from the separation area are connected to the separation area by gluing, stapling or the like, for example.

The insertion areas and connecting flaps are intended and configured for detachably connecting a separation element to another separation element, specifically another separation element as described herein and in the following. The insertion areas are located in the separation area (within the surface of the separation area) or at the edge of the separation area (at the edge of the surface of the separation area). A separation element has at least a number of insertion areas that corresponds to the number of connecting flaps, possibly even more, for example four insertion areas with two opposing connecting flaps.

The special feature of the separation element consists in the latter having at least one door in the separation area and—corresponding to the number of doors—at least one door insertion area. The door or each door has at least one door insertion section that is insertable in order to fasten the door in an open state into a door insertion area, in particular a slot-shaped door insertion area (door insertion slot) of the other separation element. An open door in a separation area causes the raw gas flow to be guided, especially in the case of several separation elements arranged in staggered succession, each with at least one open door. The resulting guidance of the raw gas flow leads to changes in direction, vortex formation and/or local changes in the flow velocity, and this improves the separation effect of a separation element as well as several separation elements arranged in staggered succession.

The apparatus—the separation element (air flow separation element)—is intended and configured for separating particles, in particular paint particles, carried along in a raw gas flow. The separation element is also intended for use in a separation apparatus (air flow separation apparatus) or for use with a separation apparatus. When used with a separation apparatus, a separation apparatus of the type mentioned at the beginning or the like may be considered, for example.

Due to the intended use of the separation element for separating particles carried along in a raw gas flow, in particular paint particles, the separation element proposed herein can also be referred to as a raw gas flow particle separation element, in particular as a paint particle separation element/air particle separation element or—in the case of separation of particles due to a paint mist—as a paint mist separation element. In any case, the separation element proposed herein is intended for use in an air flow and the separation element proposed herein is used in an air flow when used as intended. The designation as an air flow separation element emphasizes, on the one hand, the use/usability in an air flow and, on the other hand, the use/usability for separating particles carried along in the respective air flow. These particles are, for example, paint particles carried along by the air flow. This emphasized by the designation “paint mist separation element.”

### SUMMARY OF THE INVENTION

A separation element of the type proposed herein can be quickly and easily connected to another separation element using the connecting flaps. As a result, two or more separation elements of the type proposed herein are or will be connected to each other. Further separation elements can be connected to separation elements that are already connected to each other by means of the connecting flaps. Such a combination of separation elements is referred to below as an air flow separation combination or separation combination for short. A separation combination comprises at least two separation elements of the type described herein and in the following (two, three, four or more separation elements) connected to each other by means of the connecting flaps. Because the separation combination comprises at least two such separation elements, each separation area comprises identical separation elements (identical parts: each separation element comprises a separation area, connecting flaps and insertion areas in the separation area and, optionally, at least one door: in addition, the separation elements may differ without ceasing to be marked as identical parts, for example in the design of the respective separation areas). A separation combination can also be created by joining two separation combinations together. Such a connection is also created by means of the connecting flaps. In a separation combination, the separation elements are arranged in staggered succession at distances determined by the respective effective length of the connecting flaps. The separation areas of the separation elements comprised by the separation combination lie in parallel or at least essentially parallel planes (straight lines along perpendicular lines erected in the centroid of the separation areas coincide or at least essentially coincide). In other words, in the case of another separation element (second separation element) connected to a separation element (first separation element), a projection of the separation area of the first separation element perpendicular to the surface of this separation area covers or at least essentially covers the separation area of the second separation element.

Relativizations used in the description presented here, such as “parallel or at least essentially parallel,” are due to possible tolerances in the production of separation elements as well as possible tolerances when joining two separation elements together. Such tolerances, especially tolerances when joining two separation elements together, can never be ruled out. For this reason, it is not always possible to speak of exact parallelism, for example, although in an ideal case exact parallelism is certainly possible.

Advantageous embodiments of the invention are the subject matter of the further claims. In this context, back-references used within the claims indicate the further development of the subject matter of the claim referred to by the features of the respective dependent claim. They are not to be understood as a waiver of the right to obtain independent, subject-matter protection for the features or feature combinations of a dependent claim. Furthermore, with regard to an interpretation of the claims and the description, if a feature is specified in more detail in a dependent claim, it must be assumed that such a limitation is not present in the respective preceding claims or in a more general embodiment of the apparatus in question. Any reference in the description to aspects of dependent claims is therefore to be read expressly as a description of optional features, even without specific reference.

The connecting flaps of a separation element determine the distance between two separation elements connected by means of said flaps. The distance is determined by the effective length of the connecting flaps.

To connect the separation element to another separation element, the connecting flaps of a separation element are bent, for example, against the surface of the separation area. A dimension of each connecting flap measured from the plane of the separation area is then regarded as its length. A respective effective length determines the distance between two separation elements connected to each other by means of the connecting flaps, specifically the distance between their separation areas.

Each connecting flap is flexibly connected to the separation area. To this end, the separation element has a buckling point in the area of a transition between the separation area and the respective flap, which is predetermined, for example, by means of a perforation, a fold or a notch or groove. In an advantageous embodiment of the separation element, each connecting flap is divided into at least two sections for the adaptation of an effective length. The subdivision is advantageously in the form of a (further) buckling point, which in turn is predetermined, for example, by means of a perforation, a fold or a notch or groove. One of the at least two sections (first section) directly connects to the separation area with the buckling point there. The first section is directly followed by another section (second section) of the at least two sections, in particular with the further buckling point that exists here.

The buckling points are linear buckling points. Each connecting flap has at least two linear buckling points, specifically one linear buckling point between the separation area and the connecting flap and at least one further linear buckling point between the at least two sections of the connecting flap. The linear buckling points of each connecting flap are parallel or at least essentially parallel to one another.

Each section, each of which is enclosed by a connecting flap, has an insertion section. Each insertion section is intended and configured to be inserted into an insertion area of another separation element. Slots in the separation area, for example, act as insertion areas. Such slots are parallel or at least essentially parallel to the linear buckling points.

Since each section of the connecting flaps has an insertion section, in that an effective length of each connecting flap can be shortened by folding at least one section, and in that each insertion section can be inserted into an insertion area of another separation element, different distances between any two separation elements connected to one another by means of the connecting flaps can easily be achieved. A maximum distance is obtained when none of the buckling points between adjacent sections of the connecting flaps is used and, accordingly, the consecutive sections of the connecting flaps are aligned with each other in a straight line or at least in an essentially straight line, all sections of the connecting flaps together determine their effective length and the insertion sections at the end of the connecting flaps are inserted into the insertion areas of the other separation element. A minimum distance is obtained when the connecting flaps are bent along the buckling point between the first section directly adjacent to the separation area and the section adjacent to it, the first sections of the connecting flaps determine their effective length and the insertion sections at the end of each first section of the connecting flaps are inserted into the insertion areas of the other separation element. Other defined distances between the maximum and minimum distances are possible, for example if the connecting flaps have more than two sections, all connecting flaps of a separation element are bent at the corresponding buckling points and the respective insertion sections are inserted into the insertion areas of the other separation element.

In such an embodiment of the separation element, a linear buckling point is located between two consecutive sections of the connecting flaps of all the connecting flaps comprised by the separation element, and an insertion section originates in the area of the buckling point, respectively. When a connecting flap is bent at the buckling point, the insertion section starting from the buckling point becomes a free end of the connecting flap and this insertion section can be inserted into an insertion area of another separation element. To connect two separation elements (first separation element, second separation element) to each other and by means of the connecting flaps, for example, all connecting flaps of the first separation element are bent at the same point—in each case after the same section—and the insertion sections extending from the resulting knicks become free ends of the connecting flaps and can be inserted into an insertion area of the second separation element. This results in a smaller distance between the two separation elements than without such bending.

The special feature of a separation element with connecting flaps with at least two sections is that the distance between two separation elements connected to each other by means of the connecting flaps can be changed. This allows areas with different flow characteristics to be created in a separation combination, for example areas where the raw gas flow flows at a high speed and areas where the raw gas flow flows at a lower speed. The respective flow characteristic or flow velocity thus results between the separation areas of two consecutive separation elements. Areas with a first flow characteristic or lower flow velocity result from a large or maximum distance between two consecutive separation elements and areas with a second flow characteristic or higher flow velocity result from a smaller or minimum distance between two consecutive separation elements. The possibility of easily creating areas with different flow characteristics, in particular different flow velocities, within a separation combination improves the suitability of the respective separation combination for separating particles carried along in the raw gas flow.

In an advantageous embodiment of a separation element with at least one door and at least one door insertion area, the door or each door is subdivided into at least two door sections for the adaptation of an effective length of the respective door. The subdivision corresponds functionally to the subdivision of the connecting flaps already mentioned. However, the subdivision of the door or each door of a separation element into at least two door sections is fundamentally independent of an actual or possibly non-existent subdivision of the connecting flaps of the separation element into at least two sections. In other words: In a separation element, the subdivision of the or each door into at least two door sections can be provided, although such a subdivision is not provided in the connecting flaps of the separation element, or vice versa, or both the door or each door and the connecting flaps can be subdivided into at least two sections or door sections in each case.

In the case of a separation element with at least one door, whereby the door or each door is divided into at least two door sections, the possibility of different distances between two separation elements connected to each other by means of the connecting flaps can also be used for separation elements with at least one door each.

For the door sections, the above applies accordingly to the sections of the connecting flaps (flap sections) and the door, which is divided into at least two door sections, comprises a first door section directly adjacent to the separation area and a second door section directly adjacent to the first door section and each door section, each of which is comprised by a door, has a door insertion section that can be inserted into a door insertion area of another air flow separation element. By inserting the door insertion section into a door insertion area, a door is fixed in the open state.

At least one separation element with at least one door in each case can also be combined with at least one separation element without a door, specifically by means of the respective connecting flaps. The resulting separation combination no longer comprises only identical separation elements, but groups of identical separation elements (identical parts). The small number of identical parts, for example exactly one type of separation elements (with or without door), exactly two types of separation elements (with and without flaps for setting a distance between two consecutive separation elements: without door and with door), exactly three types of separation elements (without door and with and without flaps for setting a distance between two consecutive separation elements: with door and with flaps without the possibility of setting a distance between two consecutive separation elements) and exactly four types of separation elements (without door and with door and respectively with and without flaps for setting a distance between two consecutive separation elements), and the number of variations thus possible is a great advantage of the innovation proposed herein.

In a preferred embodiment of the separation element, this has a rectangular separation area (air flow separation area, particle separation area), in particular a square separation area, and the separation element can be connected to another separation element in at least two different orientations (in the case of a square separation area in four different orientations) by means of the connecting flaps. In other words: In a preferred embodiment of the separation element, the latter—having a rectangular, in particular square separation area—can be connected to another separation element in a first orientation and at least one other orientation, wherein the separation element is rotated by 180° when attached to the other separation element in the first orientation in relation to an attachment in the at least one other orientation (by a multiple of 90° in the case of a square separation area).

For use in separating particles carried along in a raw gas flow, a separation combination formed with at least two separation elements of the type described herein and hereinafter or comprising at least two separation elements of the type described herein and hereinafter is preferably placed in a frame. The frame holds the separation elements comprised by the separating combination together and the frame and the separating combination placed in the frame (the separating combination received by the frame) together form a separation apparatus (air flow separation apparatus) for separating particles carried along in a raw gas flow. Advantageously, such a separation apparatus can be used alone or with at least one other, similar separation apparatus and/or with at least one separation apparatus of the type mentioned at the beginning for separating particles carried along in a raw gas flow.

Such a separation apparatus is preferably used in a paint shop or in connection with a paint shop or the like. There, at least one separation apparatus of the type described here and below is or are placed in an extraction wall or the like with a plurality of receiving compartments in at least individual receiving compartments.

The claims submitted with the application are formulation proposals without prejudice to obtaining further protection. Since the features of the dependent claims in particular may constitute separate and independent inventions in view of the state of the art on the priority date, the applicant reserves the right to make these or other combinations of features previously disclosed only in the description and/or drawing the subject matter of independent claims or divisional declarations. Furthermore, they may also contain independent inventions which have a design independent of the subject-matter of the respective claims referred to.

The overall innovation proposed herein is also the use of a separation element as described here and in the following, a separation apparatus as described here and in the following and a painting system, each for separating particles carried along in a raw gas flow.

Finally, the innovation proposed herein also pertains to a method for separating particles, in particular paint particles (paint mist separation), carried along in a raw gas flow, and according to the method the raw gas flow is passed through at least one separation element (air flow separation element), at least one separating combination (air flow separating combination) or at least one separation apparatus (air flow separation apparatus) of the type described here and in the following.

In the following, an advantageous embodiment of the invention is explained in more detail with reference to the drawings. Corresponding objects or elements are provided with the same reference numerals in all figures. In the case of elements that occur more than once, for example flaps and slots, not all elements are always marked with the respective reference numeral for the sake of clarity. In this respect, reference is made to the marked elements or a possible marking of the same element in other figures.

The exemplary embodiment is not to be understood as a limitation of the invention. Rather, additions and modifications are certainly also possible within the scope of the present disclosure, in particular those which, for example by combining or modifying individual features or process steps described in conjunction with the features described in the general or special description part and contained in the claims and/or the drawings, can be deduced by the skilled person with regard to the solution of the problem and lead to a new object or to new method steps or method step sequences by means of combinable features.

### BRIEF DESCRIPTION OF THE DRAWINGS

In the drawings:

FIG. 1 to FIG. 3 depict a separation element with means to be detachably connected to another similar separation element;

FIG. 4 to FIG. 7 depict the separation element according to FIG. 1 to FIG. 3 in a first configuration prepared for use, specifically in a configuration which, when they are connected to one another, results in a comparatively large distance between the separation elements;

FIG. 8 to FIG. 11 depict the separation element according to FIG. 1 to FIG. 3 in a second configuration prepared for use, specifically in a configuration which, when the separation elements are connected to one another, results in a smaller distance compared to the configuration in FIG. 4 to FIG. 7;

FIG. 12 depicts the separation element according to FIG. 1;

FIG. 13 and FIG. 14 depict snapshots when connecting separation elements together;

FIG. 15 and FIG. 16 depict in each case a combination resulting from the setting in FIG. 13 or FIG. 14 (separation combination);

FIG. 17 depicts a snapshot of the connection of several separation elements with each other, resulting in different distances;

FIG. 18 and FIG. 19 depict the separation combination resulting from the setting in FIG. 17 in an isometric view or in a side view;

FIG. 20, FIG. 21 and FIG. 22 depict a special embodiment of a separation element, in particular a separation element according to FIGS. 1 to 12, specifically in each case a separation element with a door;

FIG. 23 to FIG. 28 depict the separation element according to FIGS. 21, 22 in a configuration prepared for use;

FIG. 29 and FIG. 30 depict a plurality of separation elements staggered one behind the other as shown in FIGS. 21, 22;

FIG. 31 depicts a snapshot when connecting several separation elements together as shown in FIGS. 21, 22;

FIG. 32 and FIG. 33 depict a separation combination with separation elements according to FIGS. 21, 22 in an isometric view or in a side view;

FIG. 34 depicts a separation combination (separation apparatus) placed in a frame with separation elements according to FIGS. 1 to 12 and/or according to FIGS. 20 to 28;

FIG. 35 depicts a structural element acting, for example, as an extraction wall of a painting system with compartments for receiving a separation apparatus, respectively; and

FIG. 36 depicts a painting system with an extraction wall.

### DETAILED DESCRIPTION OF ILLUSTRATED EMBODIMENTS

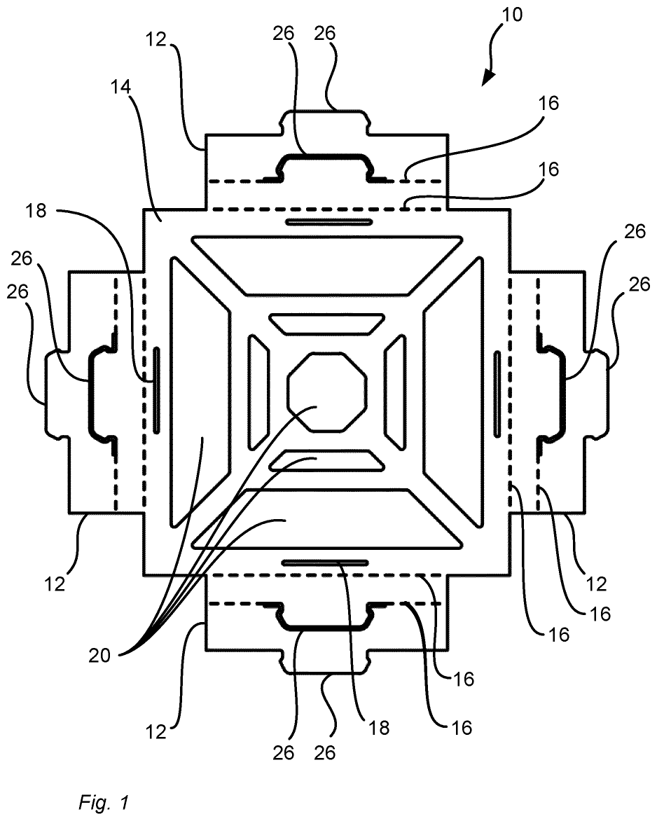

The illustrations in FIG. 1 to FIG. 12 show an embodiment of a separation element (air flow separation element) 10. Materials that may be considered include, for example, cardboard, paperboard (in particular solid board or corrugated board), plastic, metal (in particular pyrolysis-resistant metal) or the like.

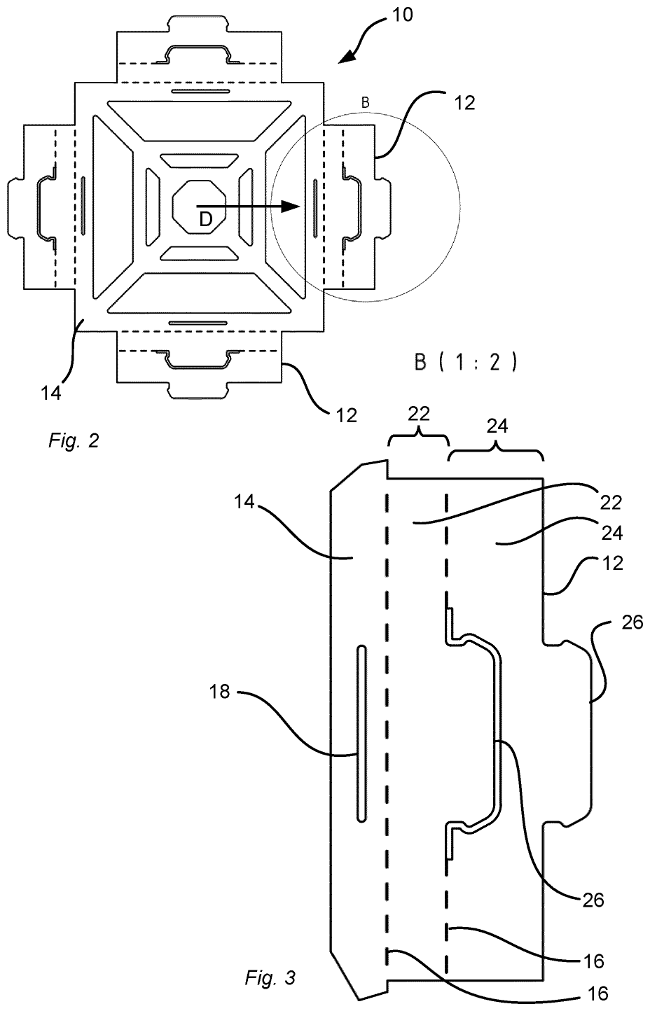

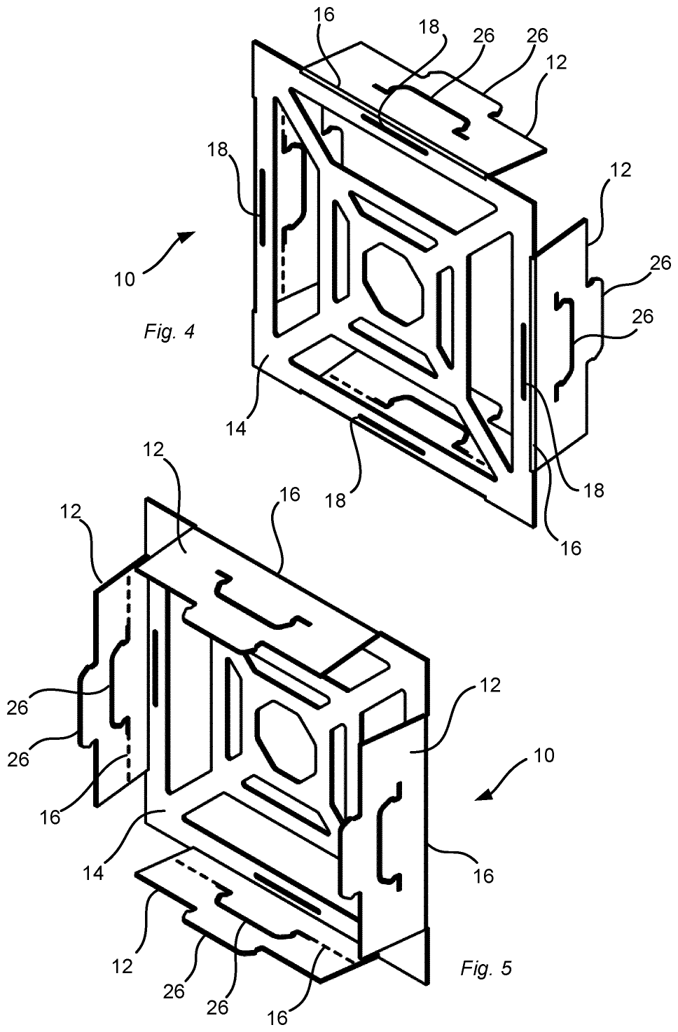

The illustration in FIG. 1 shows a separation element 10 in a possible transport/delivery configuration, specifically in a flat state. The illustration in FIG. 2 shows the separation element 10 according to FIG. 1 with an area highlighted there, and the illustration in FIG. 3 shows the area highlighted in FIG. 2 in an enlarged view.

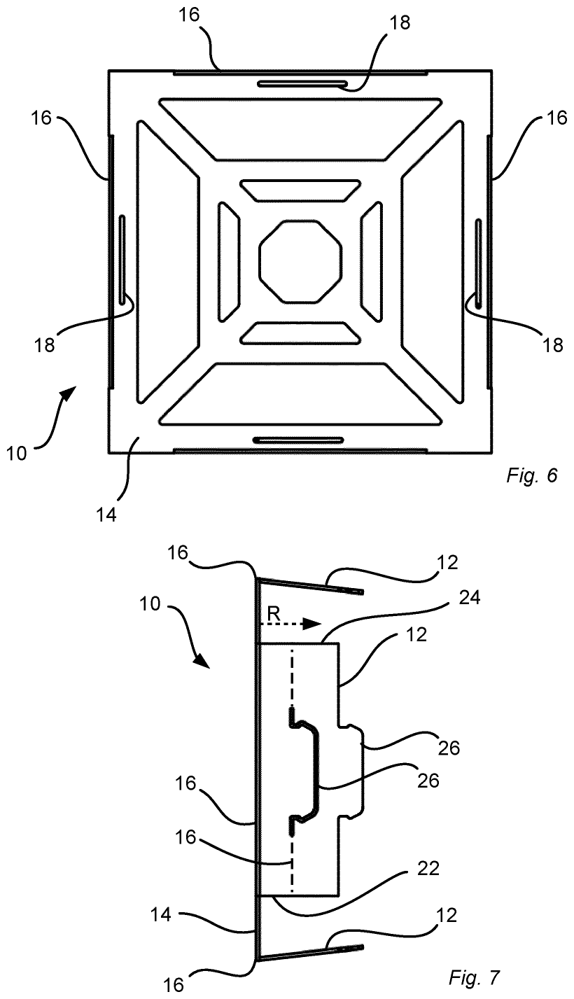

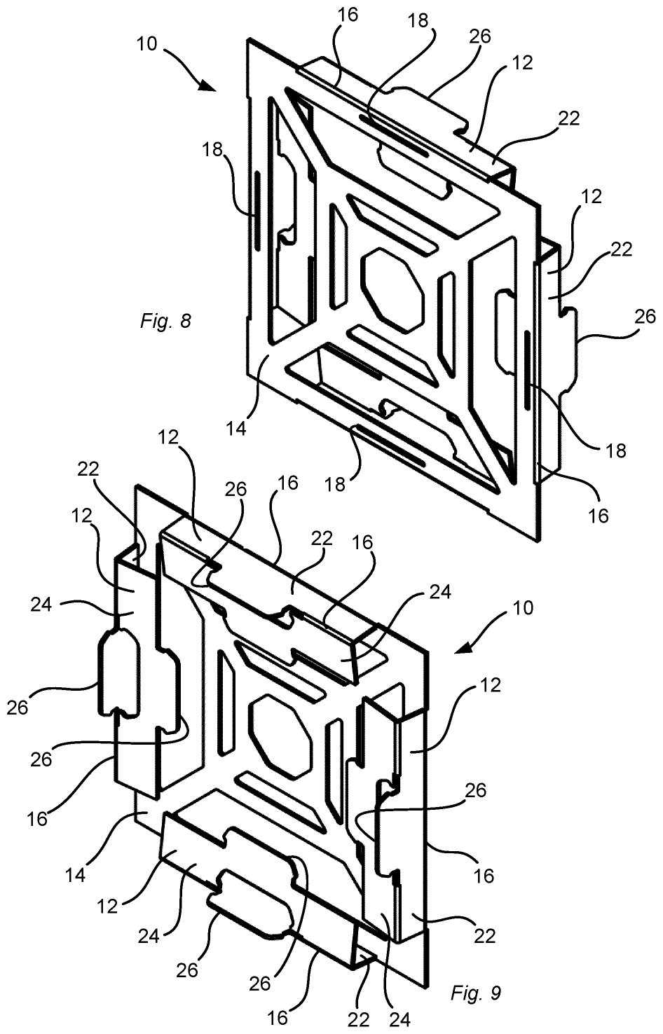

The illustrations in FIG. 4 and FIG. 5 show the separation element 10 according to FIG. 1 in a configuration prepared for use, specifically in an isometric view and essentially from the front and essentially from the rear. The illustrations in FIG. 6 and FIG. 7 show the separation element 10 in the configuration as in FIG. 4, FIG. 5 in a front view and in a side view respectively.

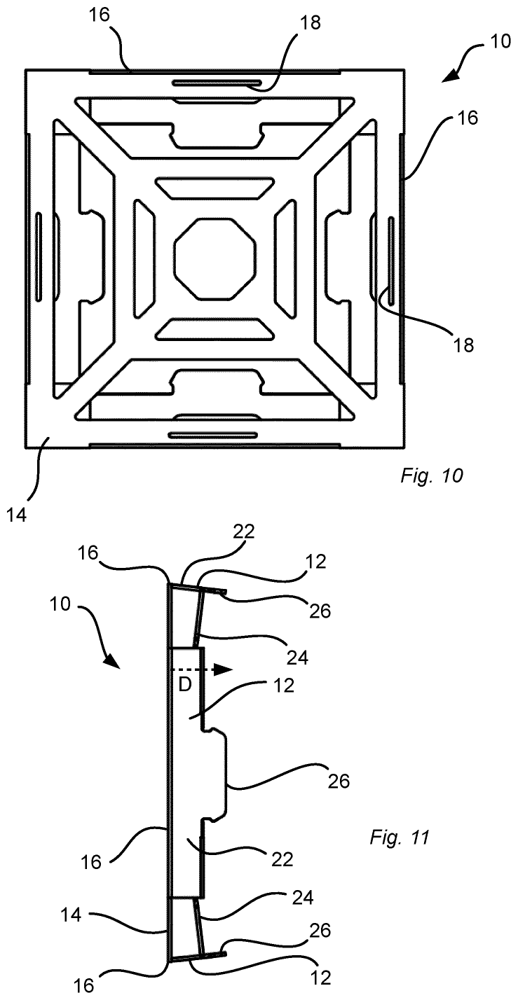

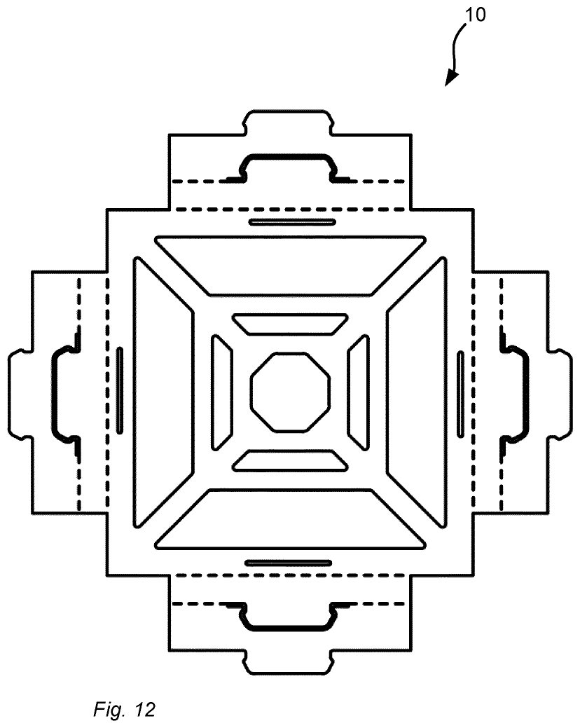

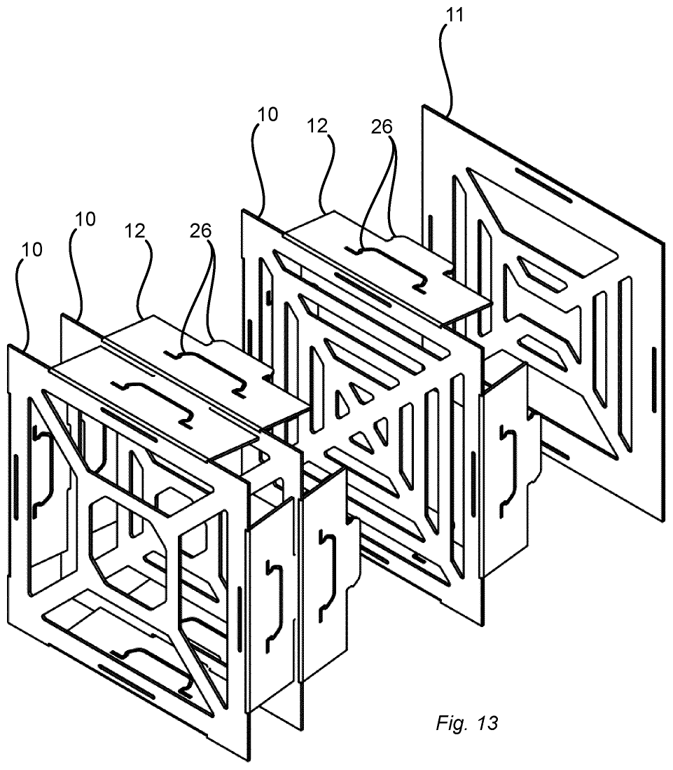

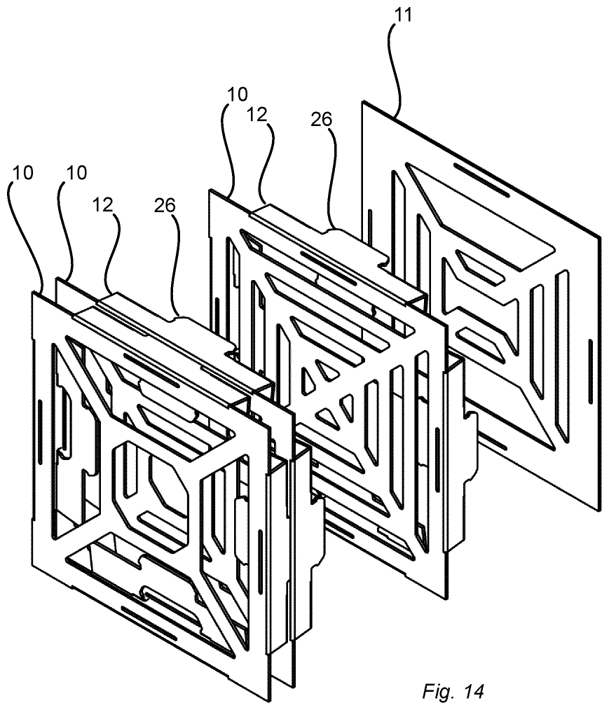

The illustrations in FIG. 8 to FIG. 11 also show the separation element 10 according to FIG. 1 in a configuration prepared for use, but in comparison with the illustrations in FIG. 4 to FIG. 7, utilizing the fundamentally optional special feature of the separation element 10, specifically the division of the connecting flaps 12 into at least two sections 22, 24, which makes it possible in a simple manner to achieve different distances between two respective separation elements 10 connected to one another by means of the connecting flaps 12. The illustrations in FIG. 8 and FIG. 9 show isometric views of the separation element 10 and the illustrations in FIG. 10 and FIG. 11 show the separation element 10 in a front view and a side view, respectively.

For a better overview of the relationships shown in FIG. 1, the illustration in FIG. 12 essentially repeats the illustration in FIG. 1 without reference numerals.

A separation element 10 has means for detachable connection (connecting means 12) to a further separation element 10, in particular exactly one further separation element 10. In the embodiment shown, a separation element 10 has four connecting flaps 12 as connecting means 12, which are connected to a central separation area 14 and are often referred to simply as flaps 12 in the following. This is merely an example. In general, a separation element 10 has several (at least two) connecting flaps 12. A separation element 10 can therefore have, for example, exactly four connecting flaps 12, in particular in each case one connecting flap 12 adjacent to or starting from in each case one outer edge of the separation area 14, or have, for example, exactly two connecting flaps 12, in particular in each case one connecting flap 12 adjacent to or starting from in each case opposite outer edges of the separation area 14. In addition, a separation element 10 can also have more than one connecting flap 12 adjacent to or starting from in each case one outer edge of the separation area 14 or in each case one outer edge. Preferably, each flap 12 connects centrally to a respective outer edge of the separation area 14 or extends centrally from a respective outer edge of the separation area 14.

The further description is continued, without waiving any further generality, on the basis of flaps 12 as means for detachable connection (connecting means 12) to a further separation element 10, in particular exactly one further separation element 10, and on the basis of four flaps 12 spaced evenly along a circumferential line of the separation area 14.

The flaps 12 enclose the separation area 14. The separation area 14 has a separating surface for separating particles carried along in a raw gas flow R (FIG. 18). The separation element 10 comprises the central separation area 14 and the adjoining flaps 12 preferably, as in the embodiment shown, in a one-piece form. In other words, each flap 12 is integrally connected to the separation area 14 (flaps 12 adjoining the separation area 14). In this respect, the further description is also continued, again without waiving any further general validity, with reference to the exemplary embodiment shown, i.e. with reference to a one-piece separation element 10 that comprises a central separation area 14 and flaps 12 adjoining it and integrally connected thereto.

Each flap 12 is flexibly connected to the separation area 14. To obtain a configuration as shown in FIG. 4 to FIG. 7, each flap 12 is folded back against the plane of the separation area 14. For this purpose, the separation element 10 has a marking, a perforation, a fold (or fold line), a notch (or notch line) or groove or the like, hereinafter collectively referred to as buckling point 16, in the area of the transition between the separation area 14 and the respective flap 12 as an articulated connection. The bending of each flap 12 in the area of the respective buckling point 16 and against the plane of the separation area 14 is effected, as shown, with an angle of approximately 90° (more precisely: slightly over 90°, for example 100°; see FIG. 7).

When the flaps 12 are folded over, the previously flat separation element 10 takes on a spatial shape (FIG. 4 to FIG. 7 or FIG. 8 to FIG. 11). As long as the flaps 12 are not folded over, i.e. in the case of flat separation elements 10, they only take up a very small volume. This is a great advantage, especially when transporting a large number of separation elements 10 to a particular place of use.

In addition to the flaps 12, a separation element 10 has insertion areas 18 in the separation area 14 or at the edge of the separation area 14. A separation element 10 has at least a number of insertion areas 18 corresponding to the number of flaps 12, possibly more, for example four insertion areas 18 in the case of two flaps 12 located opposite one another. Advantageously, the separation element 10—as in the embodiment shown—has four insertion areas 18 spaced evenly along a circumferential line of the separation area 14, in each case centrally to the outer edges of the separation area 14 and aligned with the flaps 12.

In the exemplary embodiment shown, slots 18 in the separation area 14 function as insertion areas 18. The slots 18 each run parallel to the articulated connection between the nearest flap 12 and the separation area 14, i.e. parallel to the buckling point 16 between the nearest flap 12 and the separation area 14. The further description is also continued here and also without waiving any further generality on the basis of the exemplary embodiment shown, specifically with exactly four slots 18 functioning as insertion area 18.

The separation area 14 is rectangular, preferably square. The separation area 14 is structured and has punched-out portions, holes or the like, referred to collectively below as holes 20. When the separation element 10 is used for separating particles carried along in a raw gas flow R (FIG. 18), the holes 20 allow the inflowing raw gas flow R to pass through. The type and number of holes 20 and a surface structure resulting from the type and number of holes 20 and/or a hole pattern resulting from the type and number of holes 20 are not important and, accordingly, any surface structures or hole patterns are possible in principle and are to be regarded with this reference as being covered by the description presented here.

A single flap 12 and a preferred, fundamentally optional embodiment will now be considered. Please refer to the illustration in FIG. 3, which shows an enlarged version of the area labeled B in FIG. 2. The following applies accordingly to all other flaps 12 of the separation element 10.

In the preferred embodiment, each flap 12 comprises at least two sections 22, 24, in particular at least two sections 22, 24 integrally connected to each other. In that each flap 12 comprises at least two sections 22, 24, each flap 12 is subdivided into at least two sections 22, 24 or can be thought of as being subdivided into at least two sections 22, 24. These are a first section 22 immediately adjacent to the separation area 14 and a second section 24 immediately adjacent to the first section 22. In the illustration in FIG. 3, the corresponding reference numerals are on the one hand placed above curly brackets representing the area of the sections 22, 24 and on the other hand entered with reference lines ending on the surfaces of the sections 22, 24. Each flap 12 can comprise more than the two sections 22, 24 shown by way of example, for example it can comprise three, four or more sections.

A marking, a perforation, a fold (or fold line), a notch (or notch line) or creasing or the like is located between two respective adjacent sections 22, 24, hereinafter collectively referred to as buckling point 16. The buckling point 16 is provided for the defined folding back of a section (together with any further sections adjoining it) against the section immediately preceding it in the direction of the separation area 14. In the case of exactly two sections 22, 24 (first section 22; second section 24), there is accordingly exactly one buckling point 16, specifically a buckling point 16 between the first section 22 and the second section 24, said point being provided for the defined folding back of the second section 24 against the first section 22.

Each of the at least two sections 22, 24 is used for the adaptation of an effective length of the respective flap 12, and each flap 12 is divided into the at least two sections 22, 24 for the adaptation of an effective length of the respective flap 12.

The length of a flap 12 and the length of each section 22, 24 that it encloses is measured—in the case of a still flat separation element 10—in a direction D starting from the center of the separation area 14 (see FIG. 2) or—in the case of flaps 12 already bent towards the plane of the separation area 14—in a direction D starting from the plane of the separation area 14 (see FIG. 7, FIG. 11). The length of a flap 12 as a whole is measured in this direction starting from the buckling point 16 between the separation area 14 and the first section 22. The length of a flap 12 is therefore independent of whether or not it is bent at the buckling point 16 between the separation area 14 and the first section 22.

A conscious distinction is made between a length and an effective length. The length of a flap 12 always corresponds to the sum of the lengths of the sections 22, 24 comprised by the flap 12. The effective length of a flap 12 depends on whether or not the flap 12 is bent at a buckling point 16 between each two adjacent sections 22, 24. The effective length of a flap 12 always corresponds to the sum of the lengths of the sections 22, 24 comprised by the flap 12, which are aligned with section 22 (first section 22) adjacent to the separation area 14. If the flap 12 is not divided into sections 22, 24 or if all sections 22, 24 comprised by the flap 12 are aligned with the first section 22, the length of the flap 12 and the effective length of the flap 12 are equal. Designating the effective length as effective is justified by the fact that the effective length of the flaps 12 determines the distance between the respective separation areas 14 in the case of two separation elements 10 connected to one another by means of the flaps 12.

In the setting shown in FIG. 3, the flap 12 clearly has an effective length that corresponds to the sum of the lengths of the two sections 22, 24. In the setting shown in FIGS. 4, 5 and 7, the flaps 12 also have an effective length that corresponds to the sum of the lengths of the two sections 22, 24, included in each case. In the setting shown in FIGS. 8, 9 and 11, the flaps 12 have an effective length that corresponds to the length of the first section 22. Therefore, the effective length of the flaps 12 is correspondingly shorter here and the adaptation of an effective length of the flaps 12 has been achieved by buckling at the buckling point 16 between the two sections 22, 24.

Two sections 22, 24 can be seen in the illustration in FIG. 7 in the flap 12 shown there in plan view and in the illustration in FIG. 3. In the illustration in FIG. 7, both sections of the flaps 12 shown there in the side view can also be seen. There, however, the buckling point 16 between the two sections 22, 24 is not visible due to the view.

In the illustration in FIG. 11, only the section 22 immediately adjacent to the separation area 14 of the flap 12 shown there in plan view can be seen. Of the flaps 12 shown in the side view in FIG. 11, both sections 22, 24 can be seen, wherein the section 22 (first section 22) directly adjacent to the separation area 14 is folded back towards the separation area 14 and the section 24 directly adjacent to the first section 22 is folded back towards the first section 22. This applies accordingly to the flap 12 shown in the plan view and the flap 12 not visible at all in the illustration of FIG. 11 (second section 24 folded back against the first section 22).

The subdivision of the flaps 12 into at least two sections 22, 24 in each case allows for an adaptation of their effective length. For the purpose of connecting a separation element 10 to a further separation element 10 by means of the flaps 12, each section 22, 24 comprised by a respective flap 12, has an insertion section 26, specifically an insertion section 26 which can be inserted into a slot 18 in the further separation element 10. Each flap 12 has an insertion section 26 at the end of a respective flap 12. In the case of a flap 12 with exactly two sections 22, 24 (first or inner section 22, adjacent to the separation area 14: second or outer section 24, adjacent to the inner section 22), the flap 12 thus has the insertion section 26 at the end of the second section 24. This insertion section 26 is used when connecting to a further separation element 10 if a large distance between the separation elements 10 is desired.

Since each flap 12 has an insertion section 26 at each section 22, 24 comprised thereby (preferably centered), after the buckling of a section of the flap 12 against the section immediately preceding this section, the insertion section 26 of said immediately preceding section becomes free and can be used when connecting to a further separation element 10. In the case of a flap 12 with exactly two sections 22, 24 (first or inner section 22, adjacent to the separation area 14: second or outer section 24, adjacent to the inner section 22), the insertion section 26 of the inner section 22 becomes free (is detached from the surface of the outer section 24) after the outer section 24 has been folded over against the inner section 22 and can be used for connecting to a further separation element 10. Now the effective length of the flap 12 is reduced to the length of the first, inner section 22 and the connection to the further separation element 10 is made with a smaller distance.

The insertion sections 26 are designed to match the slots 18 functioning as insertion areas 18, such that insertion, in particular form-fit insertion of an insertion section 26 into the insertion area/slot 18, specifically the insertion area/slot 18 of another separation element 10, is possible. Optionally, the insertion sections 26, as shown, are slightly oversized in sections compared to the length of a slot 18, so that due to the oversize, for example, resulting flaps or the like on the side of the insertion section 26 in the inserted state in a slot 18 fix the insertion section 26 in the slot 18 and thus on another separation element 10.

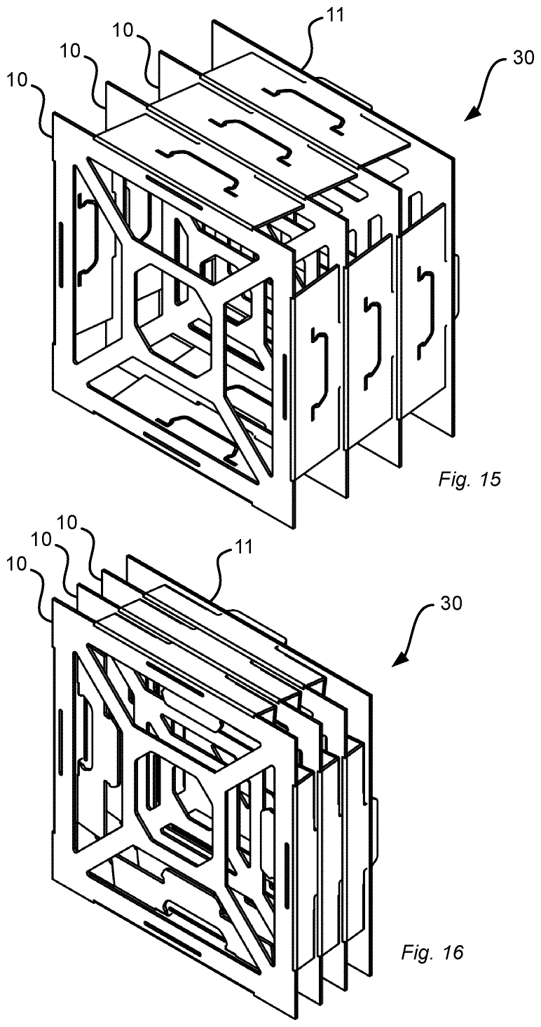

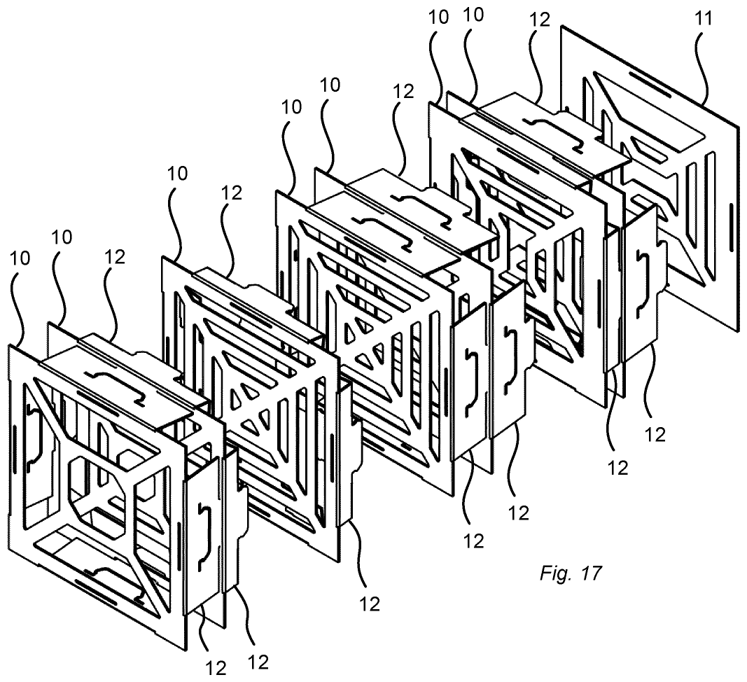

The illustrations in FIG. 13 and FIG. 14 show exemplary snapshots when separation elements 10 are connected to each other. Three separation elements 10 are shown in each case. The separation elements 10 shown on the far left are already connected to each other by means of the flaps 12 and the two separation elements 10 already connected to each other can then be connected to the further separation element 10, by means of the still free flaps 12 of the separation elements 10 already connected to each other. A further separation element 10 can then be connected to the still free flaps 12 (and this can be continued in any order) or a special end separation element 11 (a separation element without flaps 12) can be connected.

Several separation elements 10 can be connected to each other in any order. This applies to a larger number of separation elements 10 and to groups two or more separation elements 10 connected to each other.

The illustration in FIG. 13 shows a setting where said connection occurs with a comparatively large distance between the separation areas 14 of the individual separation elements 10. The illustration in FIG. 14 shows a setting where said connection is made with a smaller distance between the separation areas 14 of the individual separation elements 10 compared to the setting in FIG. 13. These distances result in each case from the effective length of the flaps 12. In the setting in FIG. 13, the effective length of the flaps 12 results from the length of the at least two sections 22, 24 comprised by the flaps 12. In the setting in FIG. 14, the effective length of the flaps 12 results from the length of section 22 of the flaps 12 immediately adjacent to the separation area 14.

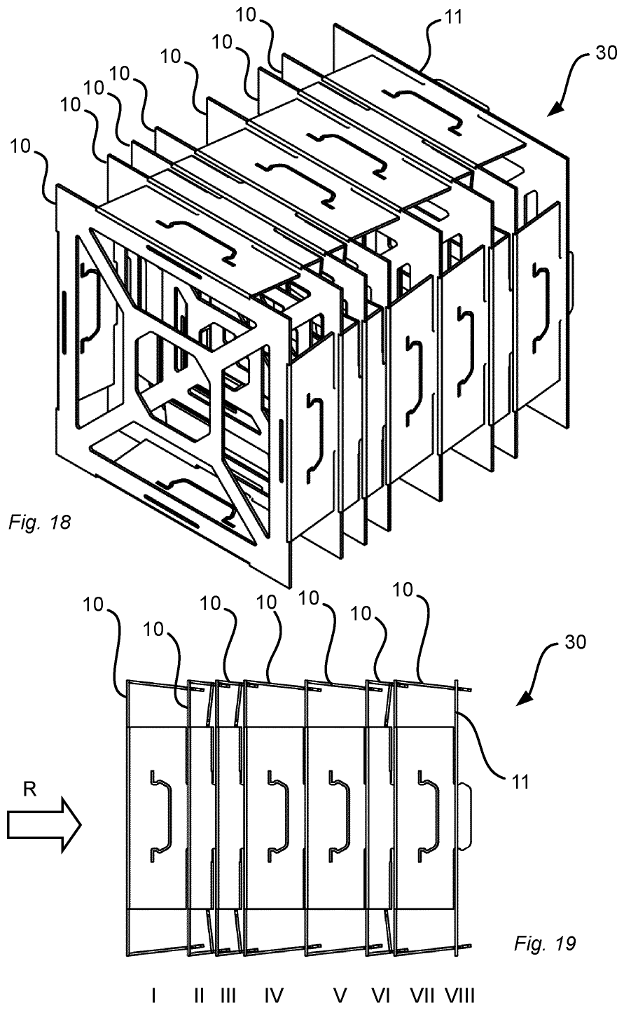

The illustrations in FIG. 15 and FIG. 16 each show a combination resulting from the setting in FIG. 13 and FIG. 14, respectively. Such a combination, specifically a combination comprising at least two separation elements 10 connected to each other as shown here and in the following, is a separation combination 30 and referred to in the following as separation combination 30. A separation combination 30 comprises a plurality (at least two) of separation elements 10 connected to one another and arranged in staggered succession in the connected state.

The illustration in FIG. 17 shows an exemplary snapshot when connecting several separation elements 10 to each other, wherein different effective lengths of the flaps 12 are used. The illustrations in FIG. 18 and FIG. 19 show the separation combination 30 resulting from the setting in FIG. 17 in an isometric view and in a side view, respectively. Here, the different distances between the separation areas 14 of the separation elements 10 resulting from the different effective lengths of the flaps 12 are clearly apparent.

In the illustration in FIG. 19, the block arrow pointing towards the separation combination 30 also shows the direction of a raw gas flow R which, when the separation combination 30 is used, flows towards it and passes through the separation areas 14 of the separation elements 10 surrounded by it, i.e. flows through the individual separation areas 14. As it flows through, the separation of particles carried along in the raw gas flow, in particular paint particles, takes place on the surface of the separation areas 14 and the edge lines and/or edge surfaces of the holes 20 in the separation areas 14.

In the illustration in FIG. 19, the separation elements 10 are assigned Roman numerals for ease of reference. The first separation element 10, Roman numeral I, is the separation element 10 shown on the far left, which is hit first by the inflowing raw gas flow R. The second separation element 10, Roman II, is located downstream of the first separation element 10 (behind the first separation element 10) in relation to the flow path of the raw gas flow R and is connected to the first separation element 10 by means of the flaps 12. The third separation element 10, Roman III, is located downstream of the second separation element 10 (behind the second separation element 10) with respect to the flow path of the raw gas flow R and is connected to the second separation element 10, and so on. The final separation element 11, which functions like a separation element 10 and is connected to a separation element 10, specifically to the separation element 10 marked by Roman VII, is to be regarded as one of the other separation elements 10, at least with respect to the separation of particles carried along in the raw gas flow R.

The separation elements 10 comprised by a separation combination 30 are connected to one another in that the insertion sections 26 of the flaps 12 of one separation element 10 are inserted into the slots 18 of another separation element 10 that follows next (hereinafter in the sense of the sequence one behind the other and as described further below) in the staggered arrangement. No flaps 12 of another separation element 10 are inserted into the slots 18 of a front, first separation element 10 of a separation combination 30. A rear, last separation element 10 of a separation combination 30 either has no flaps 12 (it is then a separation element 10 in the form of a final separation element 11) or its flaps 12 are free, i.e. not inserted into the slots 18 of another separation element 10. In the case of the or each separation element 10 possibly located between the first and the last separation element 10, the insertion sections 26 of the flaps 12 of another (preceding) separation element 10 are inserted into its slots 18 and its insertion sections 26 are inserted into the slots 18 of another (subsequent) separation element 10.

Speaking of a first or front separation element 10 and a last or rear separation element 10 as well as a total of preceding and subsequent separation elements 10 is justified against the background of the subsequent use of the separation combination 30: When used as intended, for example when used in a paint shop, the separation combination 30 is flowed against by a raw gas flow R loaded with particles and the raw gas flow R flows through the separation combination 30, specifically through the holes 20 in the separation areas 14 of the individual separation elements 10. The first or front separation element 10 (separation element I) is the separation element 10 that the raw gas flow R encounters first. The last or rear separation element 10 (or final separation element 11: separation element VII) is correspondingly the separation element 10, 11 which the raw gas flow R encounters last and through whose holes 20 the raw gas flow R flows last. A separation element 10 which precedes another separation element 10 is located upstream of this separation element 10 in the direction of the raw gas flow R. Correspondingly, a separation element 10 which follows another separation element 10 is located downstream of this separation element 10 in the direction of the raw gas flow R.

Because a separation combination 30 by definition comprises a plurality (at least two) of separation elements 10 interconnected by means of the flaps 12 (by means of the insertion sections 26 of the flaps 12 and the slots 18 of the separation areas 14), the first two separation elements 10 (separation elements I, II) or the first three separation elements 10 (separation elements I, II, III), for example, also form a separation combination 30. In general, in the case of interconnected separation elements 10, all separation elements 10 comprised by the cluster are a separation combination 30, but also within such a separation combination 30, each group of at least two interconnected separation elements 10 (separation element group) is a separation combination 30. Accordingly, in the illustration in FIG. 19, the second and third separation elements 10 (separation elements II, III), the second, third and fourth separation elements 10 (separation elements II, III, IV), the third and fourth separation elements 10 (separation elements III, IV), etc. are each together a separating combination 30 or a separation element group. This applies accordingly to configurations other than those shown in FIG. 19, i.e. in the case of more or fewer separation elements 10.

On the left-hand side in the illustration in FIG. 19, particles to be separated by means of the separation elements 10, in particular paint particles, are produced, for example due to the operation of a paint shop or the like. On the left-hand side in the illustration, the raw gas flow R is accordingly loaded with such particles (the raw gas flow R carries such particles with it: the side there is the so-called dust air side). On the right-hand side in the illustration, the quantity of particles carried by the raw gas flow R is significantly reduced (the side there is the so-called clean air side), because at least some of the particles carried by the raw gas flow R, usually a large proportion of the particles carried, have been separated at the separation elements 10.

Due to different distances between the separation areas 14 of the separation elements 10 surrounded by a separation combination 30, areas with different flow velocities occur when a raw gas flow R flows through. When the raw gas flow R hits a separation area 14 and the material sections between the holes 20, the raw gas flow R is deflected and vortices are formed. The resulting vortices can form between two consecutive separation areas 14. With larger distances between two consecutive separation areas 14, the formation of vortices and thus also the flow velocity of the raw gas flow R in this area is different than with smaller distances between two consecutive separation areas 14. Even if this has not yet been conclusively verified by measurement at the time of writing of the description presented here, it is assumed that a lower flow velocity of the raw gas flow R prevails in an area of greater distances between two consecutive separation areas 14 than in an area of smaller distances between two consecutive separation areas 14. By means of the flaps 12 divided at least into two sections for the adaptation of an effective length, precisely this different vortex formation and/or flow velocity depending on the respective distance is intended and achieved.

The illustrations in FIG. 13 and FIG. 14 and the further figures based on the setting shown in FIG. 13 and FIG. 14 show an advantageous but nevertheless optional embodiment with separation elements 10 with different hole patterns, specifically separation elements 10 with separation areas 14 with different hole patterns in each case. A respective hole pattern is determined, for example, by the number and size of the holes 20 in the separation area 14. In the settings shown, the number of holes 20 increases (progressive increase) along the separation elements 10, which are arranged in staggered succession in the interconnected state. Optionally, the size of the holes 20 also decreases in the same direction. With at least an increasing number of holes in this sense, the result is a separation combination 30 with a progressive structure.

In the illustrations in FIG. 13 to FIG. 19, only a few reference numbers are entered in the interest of maintaining an overview of the illustrations. In this respect, reference is made to FIGS. 1 to 11.

Preferably, all flaps 12 of a separation element 10 comprise the same number of sections 22, 24. Optionally, the sections 22, 24 of the flaps 12 corresponding to each other are of the same size, at least of the same length. In such a case, in the case of flaps 12 with exactly two sections 22, 24 (first section 22: second section 24), all first sections 22 are therefore of the same length and likewise all second sections 24 are of the same length.

Alternatively, the respective corresponding sections 22, 24 of flaps 12 opposite each other at the separation area 14 are each of the same size, at least of the same length, so that in each case pairs of sections 22, 24 of the same size, at least of the same length, result. Here, flaps 12 with a different number of sections 22, 24 are also possible, for example a pair of flaps 12 with two sections 22, 24 and a further pair of flaps 12 with more than two sections 22, 24 or generally a pair of flaps 12 with a first number of sections 22, 24 (at least one) and a further pair of flaps 12 with a second number of sections 22, 24 (at least one), wherein the first number and the second number are different. Additionally or alternatively, another subdivision of a single flap 12 is also possible instead of sections 22, 24 each having the same length. In the case of a flap 12 with exactly two sections 22, 24, a subdivision of the flap 12 into sections 22, 24 of unequal length can also be provided, for example in such a way that one third of the total length of the flap 12 is divided into one of the sections 22, 24 and two thirds into the other section 24, 22. This applies accordingly to other fractions (for example ¼ to ¾; ⅖ to ⅗ etc.). Furthermore, all this also applies accordingly in the case of flaps 12 with more than two sections 22, 24. With this alternative, there are even further possibilities for different distances between separation elements 10 connected to one another by means of the flaps 12. In the case of flaps 12 of equal length in pairs, it is possible that the flaps 12 not used when connecting a separation element 10 to a further separation element 10 are torn off or cut off, for example along one of the buckling points 16, in particular along the buckling point 16 with the separation area 14.

By means of the flaps 12, a separation element 10 (first separation element 10) can be detachably connected to a further separation element 10 (second separation element 10) in a particularly simple and quick manner. In other words, a first separation element 10 can be detachably connected to a second separation element 10 by means of the flaps 12; a first separation element 10 is detachably connected to a second separation element 10 by means of the flaps 12. For this purpose, the insertion sections 26 of the same section 22, 24 of the flaps 12 of the first separation element 10 are each inserted into the slots 18 of the second separation element 10 (one insertion section 26 in each slot 18). A respective effective length of the flaps 12 thereby determines the distance between the two separation elements 10 connected to each other in this way. More precisely: the effective length of the flaps 12 determines the distance between the separation areas 14 of the two separation elements 10 connected to each other. In such a connected configuration, the separation areas 14 of the two separation elements 10 are parallel or at least essentially parallel to each other. Accordingly, a flap 12 also functions as a means for ensuring a defined distance (spacer means) between two separation elements 10 and their separation areas 14. Accordingly, an individual flap 12 and the entirety of the flaps 12 of a separation element 10 is a spacer and connecting means 12 (spacer connecting means) or a spacer and connecting device (spacer connecting device).

Just as two separation elements 10 can be connected to each other as described, further separation elements 10 can be added to such a combination. In order to do so, the insertion sections 26 of the flaps 12 are inserted into corresponding slots 18.

Separation elements 10 can be easily connected to each other and by means of the flaps 12 only at a respective place of use and the connection of separation elements 10 to each other is so simple that the connection can also be carried out by untrained personnel. In order to maintain the intended sequence of separation elements 10 (for example in the case of separation elements 10 with different hole patterns), these are preferably provided with a clear marking, for example numbered in the area of the flaps 12 and/or provided with a color code.

In principle, each insertion section 26 of an individual flap 12 of a separation element 10 can be inserted into each slot 18 of another separation element 10. To connect a separation element 10 to a further separation element 10 by means of the flaps 12, specifically the flaps 12 each comprising at least two sections 22, 24 and correspondingly at least two insertion sections 26, the respective corresponding insertion sections 26 are inserted into the slots 18 of the other separation element 10. In this sense, corresponding insertion sections 26 in the case of flaps 12 with exactly two sections 22, 24 (first section 22: second section 24) are, on the one hand, the insertion sections 26 on the first section 22 and, on the other hand, the insertion sections 26 on the second section 24. For flaps 12 with more than two sections, this applies accordingly.

When inserting all corresponding insertion sections 26 of a separation element (first separation element) 10 into a respective slot 18 of another separation element (second separation element) 10, there are, for separation elements 10 with rectangular separation areas 14, at least two possibilities for connecting the first separation element 10 with the second separation element 10, and for separation elements 10 with rectangular separation areas 14 four (exactly four) possibilities for connecting the first separation element 10 with the second separation element 10. These at least two or four connection possibilities result from a possible rotation of the two separation elements 10 relative to each other. In the case of separation elements 10 with square separation areas 14, the first separation element 10 can be connected to the second separation element 10 with a rotation in steps of 90°, so that orientations of 0°, 90°, 180°, 270° and 360° (=0°), i.e. four different possible orientations, result as possible orientations of the first separation element 10. In the case of separation elements 10 with only rectangular separation areas 14 (excluding the special square shape), the first separation element 10 can be connected to the second separation element 10 with a rotation in steps of 180°, so that orientations of 0°, 180° and 360° (=0°), i.e. two different possible orientations, result as possible orientations of the first separation element 10.

Said possibility of rotating the separation elements 10 relative to one another is particularly advantageous for corresponding separation areas 14. In the case of such separation areas 14, these each have the same hole pattern, are divided (at least in thought) along the diagonals or the central longitudinal axes into four quarters (quartered separation area 14) and have a different hole pattern (partial hole pattern) at least in two adjacent quarters or have different partial hole patterns along a circumferential/edge line of the separation area 14, in particular a different partial hole pattern in each quarter.

In a separation combination 30 formed with such separation elements 10 with such separation areas 14, its separation elements 10 each have the same hole patterns in a rectangular, in particular square separation area 14, the separation elements 10 are rotated relative to one another (by 90° or multiples of 90°) and the separation elements 10 each have a separation area 14 with four quarters (each separation area is divided at least thought into four sections (quarters)). Furthermore, the separation elements 10 have a different partial hole pattern at least in two adjacent quarters or the separation elements 10 have different partial hole patterns along a circumferential/edge line of the separation area 14, in particular a different partial hole pattern in each quarter.

A symbolic representation of a quartered deposition area 14 of a deposition element 10 and the partial hole patterns there is possible as follows, where A, B, C and D symbolically represent different partial hole patterns:
A B
D C

With three exemplary separation elements 10 (first separation element 10, second separation element 10, third separation element 10), which are rotated relative to one another by 90°, a configuration that may be a result therefrom can thus be represented as follows, with the symbolic representation of the separation elements 10 being shown here next to each other, while in a separation combination 30 the separation elements 10 are arranged in staggered succession:

| | | |
|---|---|---|
| A B | D A | C D |
| D C | C B | B A |
| (first | (second | (third |
| separation | separation | separation |
| element 10) | element 10) | element 10) |

It is to be shown that even with separation elements 10 with the same hole pattern (here a hole pattern with the partial hole patterns symbolically marked A, B, C, D in each quarter of the separation areas 14), when the separation elements 10 rotate relative to one another within the separation combination 30, different partial hole patterns lie one behind the other in the direction of flow, so that a direct flow through a separation combination 30 formed by such separation elements 10 and separation elements 10 arranged in such a manner is prevented. This leads to a deflection of the raw gas flow R and/or to the formation of vortices between the separation elements 10, which improves the separating effect. The setting of a closed surface is also expressly considered to be a partial hole pattern. In this case, the surface area of the respective quarter is closed and has no holes (partial hole pattern without holes).

To explain the definition that the separation elements 10 in a quartered separation area 14 each have different partial hole patterns along a circumferential/edge line of the separation area 14 or have a different partial hole pattern in each quarter, several hole patterns with partial hole patterns also symbolically marked A, B, C and D are compared below:

| | | |
|---|---|---|
| A B | A B | A B |
| B A | B C | D C |

In the hole pattern shown on the left, which comprises only two different partial hole patterns (A, B), there are different partial hole patterns along the circumferential/edge line of the separation area 14, specifically the partial hole patterns A, B, A, B, [A, B, A, B etc.]. Two identical partial hole patterns therefore never follow one another along the circumferential/edge line.

With the hole pattern shown in the center, which comprises three different partial hole patterns (A, B, C), there are also different partial hole patterns along the circumferential/edge line of the separation area 14, specifically the partial hole patterns A, B, C, B, [A, B, C, B, etc.]. Here too, two identical partial hole patterns never follow one another along the circumferential/edge line.

In the hole pattern shown on the right, which comprises four different partial hole patterns (A, B, C, D), there are also different partial hole patterns along the circumferential/edge line of the separation area 14, specifically the partial hole patterns A, B, C, D, [A, B, C, D, etc.]. Here too, two identical partial hole patterns never follow one another along the circumferential/edge line. In addition, all the partial hole patterns in this hole pattern are also different, so that each quarter has a different partial hole pattern.

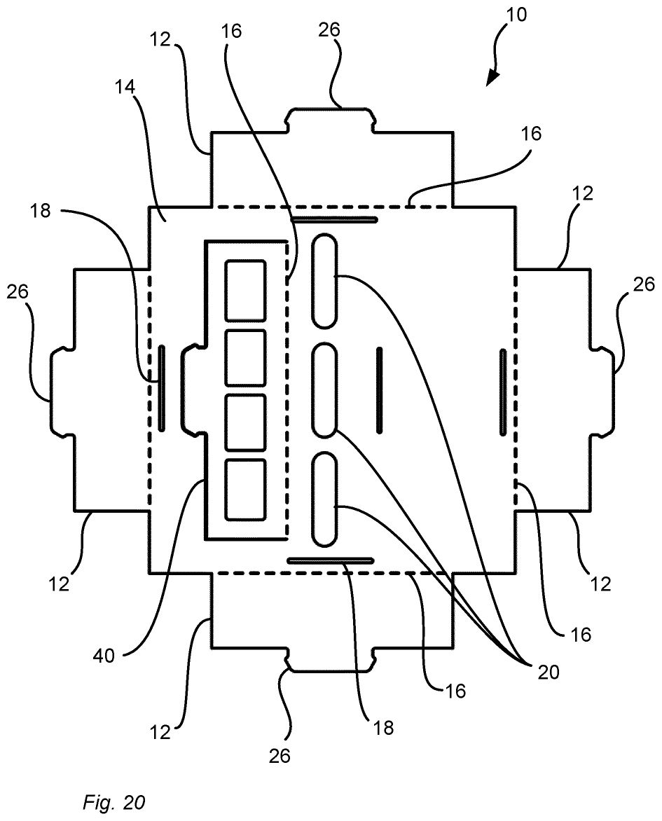

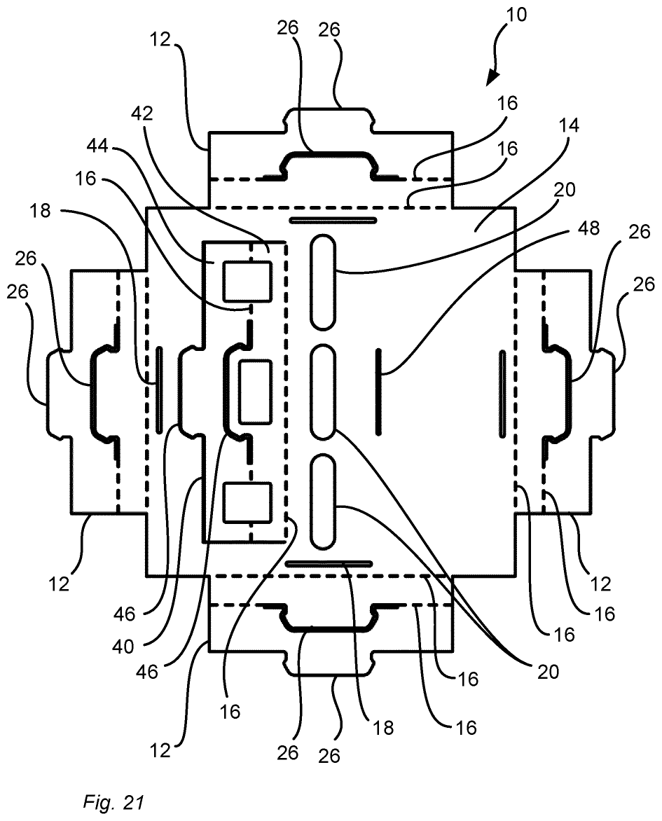

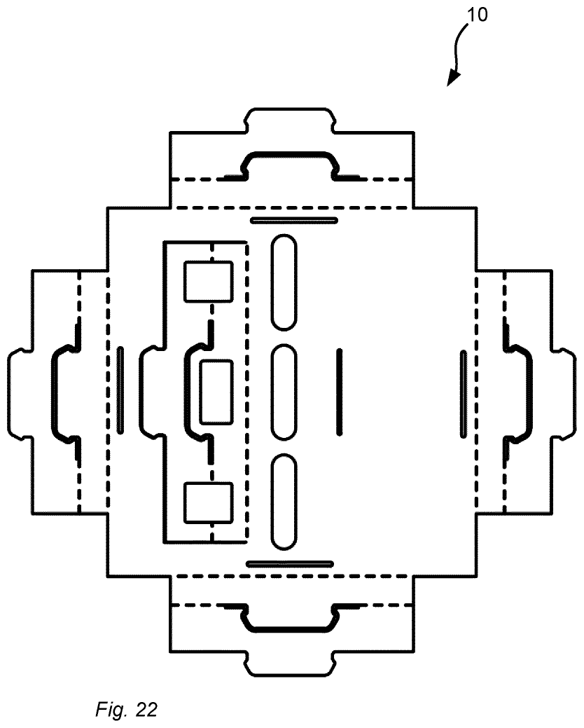

The illustrations in FIG. 20 and FIG. 21 and the subsequent illustrations based thereon now turn to the embodiment of a separation element 10 that is in the foreground here. The focus here is on a design of the separation area 14, according to which the separation area 14 a surface section which is referred to below as door 40 in accordance with its shape and mobility (mobility relative to the remaining surface of the separation area 14).

A separation element 10 can have exactly one door 40 or a plurality of doors 40 in its separation area 14. The following description is continued, expressly without waiving any further general validity, on the basis of the exemplary embodiment shown in the figures, i.e. on the basis of a separation element 10 with exactly one door 40 in its separation area 14. However, whenever a separation element 10 with exactly one door 40 is mentioned, a possible plurality of doors 40 must also always be included.

A door 40 in the separation area 14 of the separation element 10 is flexibly connected to the separation area 14. For this purpose, the separation element 10 has a marking, a perforation, a fold (or fold line), a notch (or notch line) or groove or the like as an articulated connection in the area of the transition between the separation area 14 and the door 40, hereinafter referred to collectively and in accordance with the previous terminology as buckling point 16.

A door 40 is either integrally connected to the separation area 14 in the area of the buckling point 16 and then connects to the separation area 14 in the area of the buckling point 16 or is connected to the separation area 14 in the area of the buckling point 16, for example by gluing, stapling or the like, and then extends from the separation area 14.

Insofar as reference is made here and hereinafter to a “door 40 in the separation area 14,” this is justified by the fact that in the closed state the door lies in the plane of the separation area 14 or at least essentially in the plane of the separation area 14, and by the fact that in the open state, i.e. when the door 40 is pivoted out of the plane of the separation area 14 at the buckling point 16, an opening is exposed in the surface of the separation area 14, in particular an opening corresponding to the surface of the door 40. This is preferably realized in that the door 40 is defined, on the one hand, by the buckling point 16 and, on the other hand, by an edge line adjoining the respective ends of the buckling point 16, and the surface section of the separation area 14, forming the door 40, is separated from the adjacent surface sections of the separation area 14 along the edge line by means of a cut or by means of a punching tool. Said edge line gives rise to exposed edges of the door 40, and the same edge line together with the buckling point 16 gives rise to the opening that is exposed in the surface of the separation area 14 when the door 40 is opened.

In general, a separation element 10 with at least one door 40 in its separation area 14 also has several (at least two) connecting flaps 12, in particular connecting flaps 12 as described above. In order to avoid repeating the features of the connecting flaps 12, reference is made to the previous description.

In the embodiment shown, the separation element 10 has four connecting flaps 12 adjoining the central separation area 14 and often further referred to in the following simply as flaps 12. These flaps 12 may be flaps 12 which are divided into at least two sections 22, 24 for the purpose of adapting an effective length, wherein each section 22, 24 comprised by a respective flap 12 has an insertion section 26 which can be inserted into an insertion area 18 of a further separation element 10. These flaps 12 can alternatively be flaps 12 in which such a subdivision is absent, i.e. in which each flap 12 has exactly one insertion section 26 at the end of each flap 12 which can be inserted into an insertion area 18 of a further separation element 10. The embodiment in FIG. 20 shows an embodiment of a separation element 10 with a door 40 and with flaps 12 without a subdivision of the flaps 12 into at least two sections 22, 24. The embodiment in FIG. 21 shows an embodiment of a separation element 10 with a door 40 and with flaps 12 each having at least two sections 22, 24, wherein each section 22, 24 has an insertion section 26 insertable into an insertion area 18 of a further separation element 10.

If the flaps 12 of a separation element 10 are subdivided into at least two sections 22, 24 for the purpose of adapting an effective length, the door 40 of the same separation element 10 is also subdivided in the same way into sections marked as door sections 42, 44 for the purpose of differentiation, in particular sections connected to one another in one piece, or can at least be thought of as being subdivided into such sections. Optionally, the number of sections 22, 24 of the flaps 12 and the number of door sections 42, 44 of a separation element 10 is the same in each case. In the case of flaps 12 with exactly two sections 22, 24, the door or each door 40, for example, correspondingly also comprises exactly two door sections 42, 44.

If the flaps 12 do not have a subdivision into several sections 22, 24, such a subdivision is usually not present in the door 40 either. However, the door 40 can still be subdivided, and this makes it possible to use such a separation element 10 with separation elements 10 having connecting flaps 12 of different lengths but not subdivided into a plurality of sections.

The embodiment in FIG. 21 shows a door 40 in the separation area 14 of the separation element 10 divided into two door sections 42, 44. The embodiment in FIG. 20 shows a door 40 in the separation area 14 of the separation element 10 without such a division. For a better overview of the relationships shown in FIG. 21, the illustration in FIG. 22 repeats the illustration from FIG. 21 essentially without reference numerals.

In the case of a subdivision of a door 40 into at least two door sections 42, 44, this is provided for the purpose of adapting an effective length of the door 40. Functionally, the adaptation of an effective length of the door 40 corresponds to the adaptation of the effective length of a flap 12 described above, and reference is hereby made accordingly to the description therein.

For the adaptation of an effective length of the door 40, a marking, a perforation, a fold (or fold line), a notch (or notch line) or groove or the like is located between adjacent door sections 42, 44, referred to in the following collectively and in accordance with the previous terminology as buckling point 16. The buckling point 16 is provided for the defined buckling of a door section (together with any further door sections adjoining it) against the immediately preceding door section in the direction of the separation area 14. In the case of exactly two door sections 42, 44 (first door section 42, second door section 44), there is correspondingly exactly one buckling point 16 between the door sections 42, 44, specifically a buckling point 16 between the first door section 42 and the second door section 44, and this is provided for the defined buckling of the second door section 44 against the first door section 42.

For the length of a door 40 and the length of any door sections 42, 44 comprised thereby, as well as for the effective length of a door 40, what has been said above for the length of a flap 12 and the length of sections 22, 24 comprised thereby applies accordingly and reference is hereby made thereto to avoid repetition.

The length of a door 40 of a separation element 10 corresponds to the length of the flaps 12 of this separation element 10 adjacent to the separation area 14. This applies irrespective of whether the door 40 and the flaps 12 are subdivided into a plurality of sections 22, 24 or door sections 42, 44 or not. If the flaps 12 are subdivided into at least two sections 22, 24 and the door 40 is also subdivided into at least two door sections 42, 44, the flaps 12 and the door 40 have the same number of sections 22, 24 and door sections 42, 44, for example exactly two sections 22, 24 and door sections 42, 44 in each case, and the sections 22, 24 and door sections 42, 44 corresponding to each other are of the same length in each case.

In the case of a door 40 without subdivision, this has a door insertion section 46 at its free end, preferably in the middle, which functionally corresponds to the insertion section 26 of a flap 12. In the case of a door 40 comprising at least two door sections 42, 44, each door section 42, 44 has such a door insertion section 46, preferably in the center in each case. For inserting a door insertion section 46, a slot is provided in the separation area 14 as door insertion area 48, which is also referred to below as door insertion slot 48 or slot 48 for short. For the door insertion section 46 and the door insertion area 48, what was said above for the insertion section 26 and the insertion area 18 applies accordingly and reference is hereby made to this in order to avoid repetition.

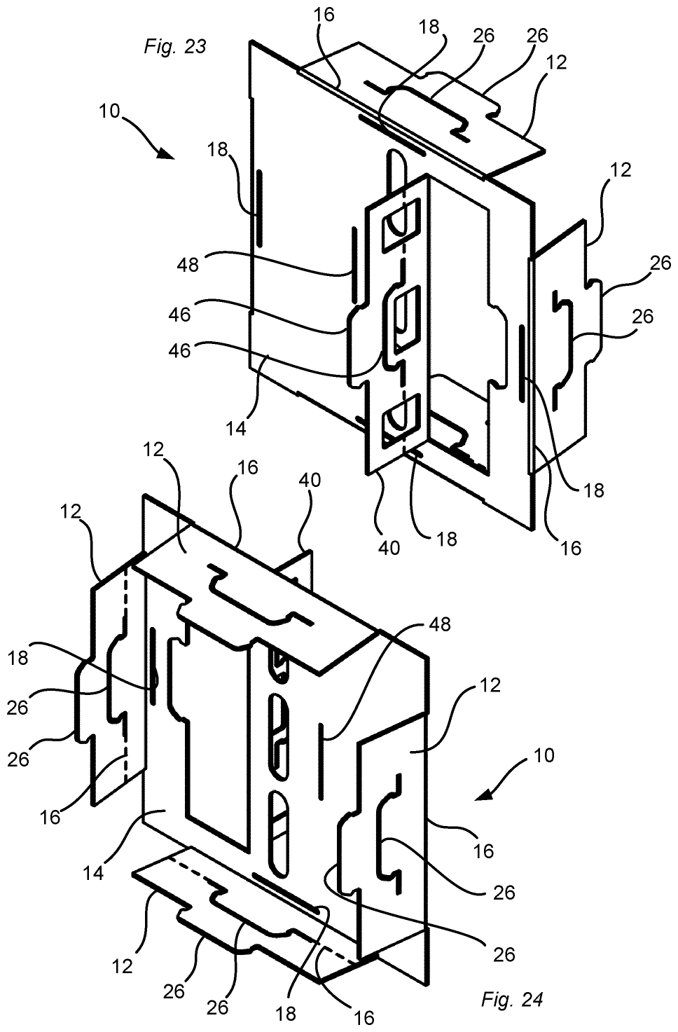

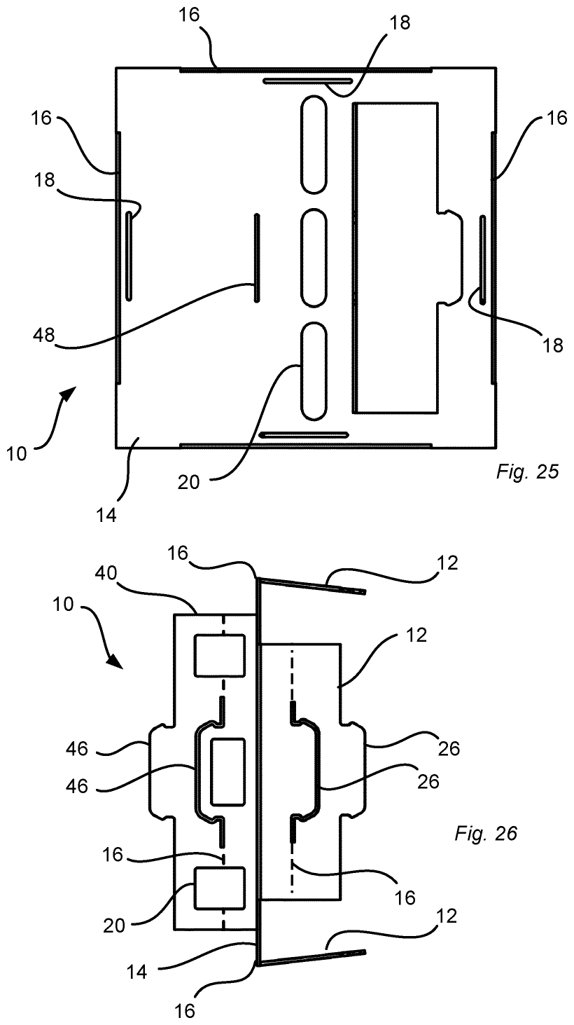

The illustrations in FIG. 23 and FIG. 24 show isometric views of a separation element 10 according to FIG. 21 and FIG. 22 in a configuration prepared for use. The illustrations in FIG. 25 and FIG. 26 show the separation element 10 according to FIG. 21 and FIG. 22 in a front view and a side view, respectively.

The separation element 10 is prepared for use by folding the flaps 12 for connection to another separation element 10 against the surface of the separation area 14 and opening the door 40. The open door 40 is swung out of the surface of the separation area 14. A setting is shown in which the flaps 12 and the door 40 are pivoted in different directions, but each by 90° or at least essentially by 90° against the surface of the separation area 14. It is also possible to swivel door 40 and flaps 12 in the same direction, this case, the door 40 with its door insertion section 46 points in the same direction as the flaps 12 with the insertion sections 26 there. The first or front separation element 10 of a separation combination 30 either has no door (it is then, for example, a separation element 10 as described in DE 20 2022 102 215.1), or the door 40 is closed in the case of a separation element 10 with door 40 or the door 40 is removed.

The connection of a separation element 10 comprising a door 40 (first separation element 10) to a further separation element 10 (second separation element 10) is carried out, for example, as follows: The door insertion section 46 at the end of the open door 40 of the first separation element 10 is inserted into the door insertion slot 48 of the second separation element 10, and the insertion sections 26 of the flaps 12 of the second separation element 10 are inserted into the slots 18 of the first separation element 10. The two separation elements 10 are thus (detachably) connected to each other and the door 40 is fixed in the open state.

In the embodiment shown, the surface section of the separation area 14 forming the door 40 is evidently located, in a fundamentally optional manner, outside the center of the separation area 14 (off-center). In the same way, the door insertion slot 48 is also located outside the center of the separation area 14 (off-center). This enables a detachable connection of several similar separation elements 10, each comprising a door 40 and a door insertion slot 48, to one another. If the door 40 of a separation element 10 is opened in the separation area 14, the opening of the door 40 results in an opening of the separation area 14 and an open area in the separation area 14. No door insertion slot 48 can be located here. This is the reason for the off-center placement of both the door 40 and the door insertion slot 48. Due to the off-center placement, when connecting two separation elements 10 (connecting by means of the flaps 12), which each have a door 40 and a door insertion slot 48, a rotation of the two separation elements 10 (first and front separation element 10, second and rear separation element 10) relative to each other by 180° is provided. The rotation brings the door 40 of the rear separation element 10 into a position behind or, depending on the orientation and visual axis, below the door insertion section 48 of the front separation element 10 (this applies in the case of an opening of the door 40 in the opposite direction to the direction of folded flaps 12). There, the door insertion section 46 of the open door 40 can be inserted into the door insertion slot 48 of the front separation element 10.

In the case of a separation element 10 with a square separation area 14 and with more than one door insertion area 48, it is also possible to rotate two separation elements 10 relative to each other by 90° or multiples of 90°. The separation element 10 then has a door insertion area 48 in the separation area 14 with an orientation as shown in the figures and at least one further door insertion area 48 with an orientation perpendicular thereto. Optionally, the door insertion areas 48 then have a shorter length compared to the length shown and, in a corresponding manner, the door or each door insertion section 46 is then also shorter. Again further optionally, the door each door insertion section 46 adjoins the respective door section 42, 44 eccentrically and the door insertion sections 48 are then positioned accordingly in the separation area 14 for receiving a respective door section 42, 44.

When the door 40 is opened in the direction of the folded flaps 12, i.e. in a different way than shown in FIG. 23 and FIG. 24, the rotation brings the door of the front separation element 10 into a position in front of or, depending on the orientation and visual axis, above the door insertion area 48 of the rear separation element 10. There, the door insertion section 46 of the open door 40 can be inserted into the door insertion slot 48 of the rear separation element 10.

In the case of a door 40 comprising at least two door sections 42, 44, this subdivision, like the corresponding subdivision of the flaps 12, serves to adapt an effective length of the door 40, and the door 40 is subdivided into the at least two door sections 42, 44 for the adaptation of its effective length.

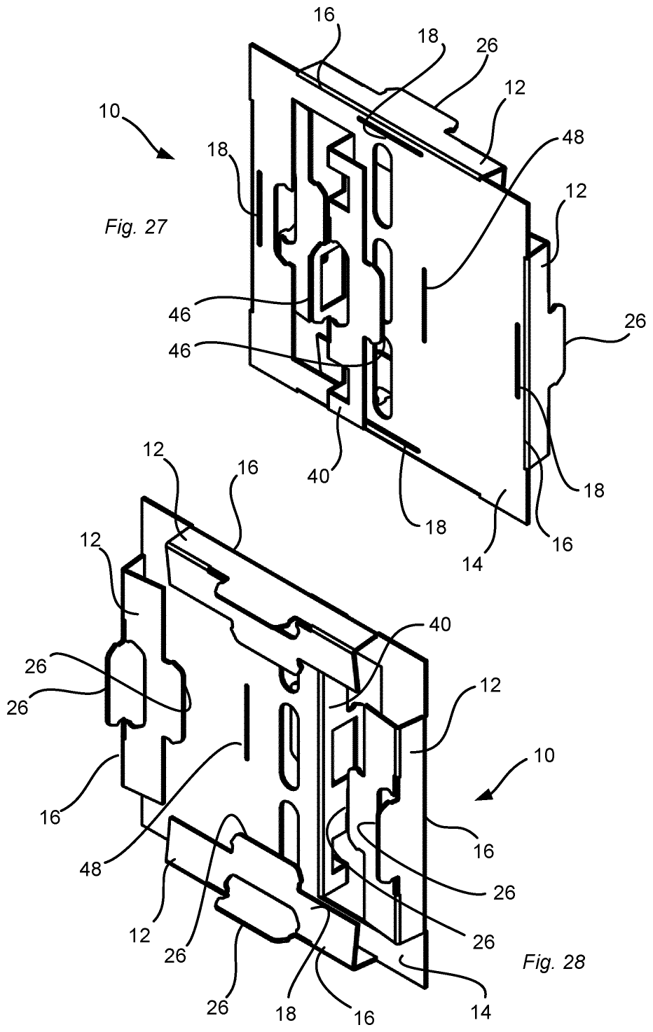

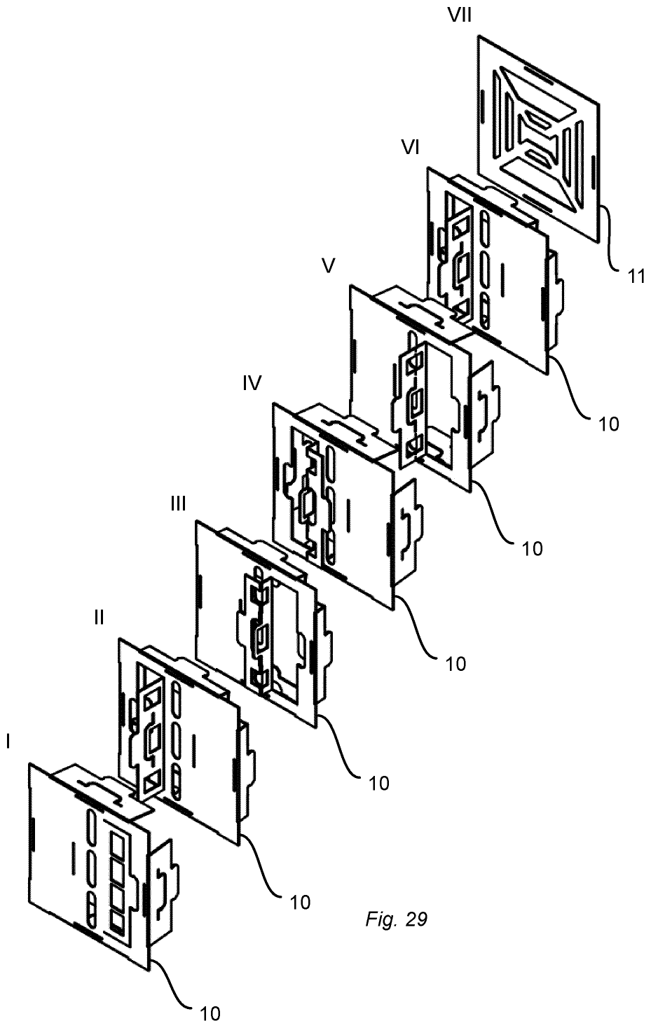

In the setting shown in FIG. 23 and FIG. 24, the door sections 42, 44 comprised by the door 40 are aligned with each other and the door 40 has an apparent effective length which corresponds to the sum of the lengths of the two door sections 42, 44. This effective length of the door 40 is provided and is used when the connection of two separation elements 10, each having a door 40 and a door insertion slot 48, is made by means of flaps 12 having the same effective length. In the setting shown in FIG. 27 and FIG. 28, on the other hand, a separation element 10 as shown in FIG. 21 and FIG. 22 is shown in which the effective length of the door 40 is reduced. The effective lengths of the flaps 12 are also reduced. The effective lengths of the door 40 and the flaps 12 are the same. Otherwise, the illustrations in FIG. 27 and FIG. 28, like the illustrations in FIG. 23 and FIG. 24, show isometric views of a separation element 10 according to FIG. 21, FIG. 22 in a configuration prepared for use. As in the illustrations in FIG. 23 and FIG. 24, a setting is shown in which the flaps 12 and the door 40 are pivoted in different directions against the surface of the separation area 14. Here too, it would also be possible for door 40 and flaps 12 to pivot in the same direction.

The reduction of the effective length of door 40 and flaps 12 occurs/is given by the fact that in each case two sections 22, 24 (first or inner flap section 22, adjacent to the separation area 14; second or outer flap section 24, adjacent to the inner flap section 22) or door sections 42, 44 (first or inner door section 42, adjacent to the separation area 14; second or outer door section 44, adjacent to the inner flap section 22) or door sections 42, 44 (first or inner door section 42, adjacent to the separation area 14: second or outer door section 44, adjacent to the inner door section 42, the outer flap section 24 is folded back against the inner flap section 22 and the inner flap section 22 is folded back against the separation area 14. and the inner flap section 22 is folded back against the surface of the separation area 14 and, in a corresponding manner, the outer door section 44 is folded back against the inner door section 42 and the inner door section 42 is folded back against the surface of the separation area 14. Said folding back occurs preferably at an angle of approximately 90°. When the outer flap sections 24 and the outer door section 44 are folded over, the insertion sections 26 of the inner flap sections 22 and the door insertion section 46 of the inner door section 42 are released (are detached from the surface of the respective outer flap or door section 24, 44). These insertion sections 26 can be inserted into corresponding slots 18 of a respective other separation element 10 and are inserted into corresponding slots 18 of the other separation element 10 in the case of two interconnected separation elements 10. In the same way, this door insertion section 46 can be inserted into the door insertion slot 48 of the other separation element 10 and is inserted into the door insertion slot 48 of the other separation element 10 in the case of two interconnected separation elements 10.

Separation elements 10 each having at least one door 40 and at least one door insertion slot 48 can be detachably connected to one another in pairs in basically the same way as described above for separation elements 10 without doors, and reference is thus again made here to what has been said above about connecting two separation elements 10 or a plurality of separation elements 10 and about forming a separation combination 30 by means of at least two separation elements 10 in order to avoid unnecessary repetition.

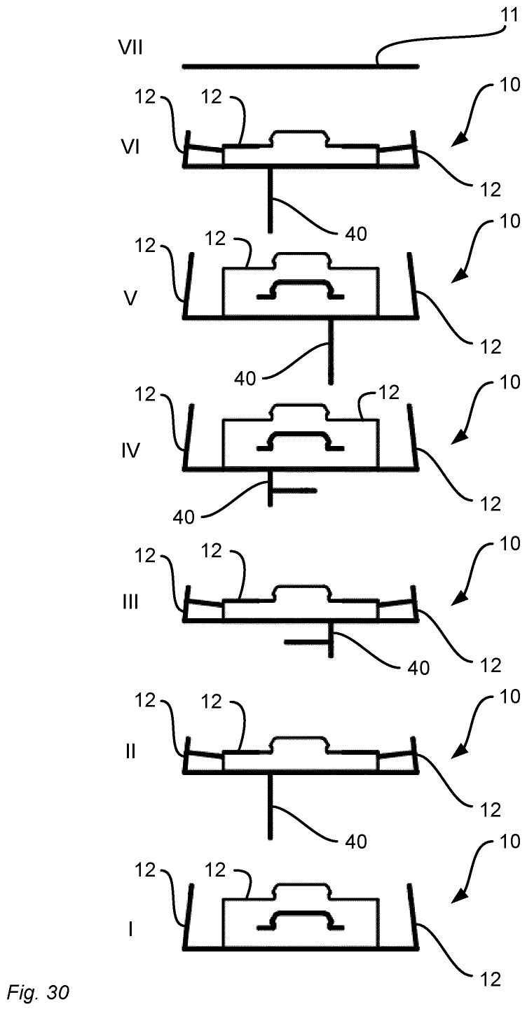

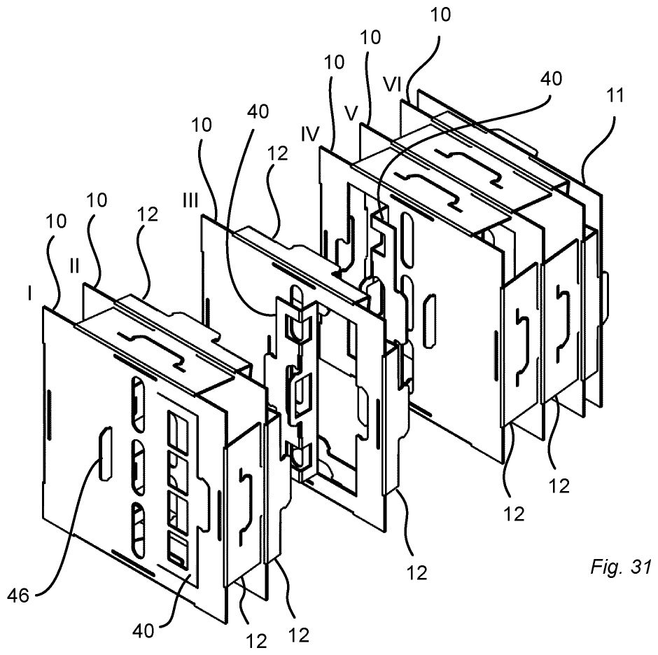

The illustrations in FIG. 29 and FIG. 30 show a plurality of separation elements 10 each with doors 40. The illustration in FIG. 29 shows these arranged in staggered succession in an isometric view and the illustration in FIG. 30 shows the same sequence of separation elements 10 in a plan view with a visual axis along the surfaces of the respective separation areas 14. The separation elements 10 are marked with Roman numerals (I to VI) for ease of reference.

It should be emphasized that the separation element 10 marked with Roman numeral I up to the separation element 10 marked with Roman numeral VI are identical separation elements 10. The recognizably different configurations result from different effective lengths of the flaps 12 and the doors 40 as well as from a respective rotation of the separation elements 10 relative to each other.

It should also be emphasized that the sequence of the separation elements 10 in the illustrations in FIG. 29 and FIG. 30 is merely an exemplary sequence and that a different number and/or a different sequence of separation elements 10 is possible at any time and should be considered to be covered by the description presented here. In the illustrations in FIG. 29 and FIG. 30, only a few reference numerals have been used in order to make the illustrations clearer.

In the illustrations in FIG. 29 and in FIG. 30, especially in the illustration in FIG. 30, the different position of the doors 40 resulting from the rotation of two separation elements 10 to be connected to each other (and connected to each other in a usable state) is clearly apparent.

With reference to the setting of the illustration in FIG. 30, the door 40 can be seen on the left side of the separation elements 10 marked with Roman II, Roman IV and Roman V and on the right side of the separation elements 10 marked with Roman III and Roman V. In the case of the separation element 10 marked with Roman I, its door 40 is not open or separated. An open door would be on the right-hand side.

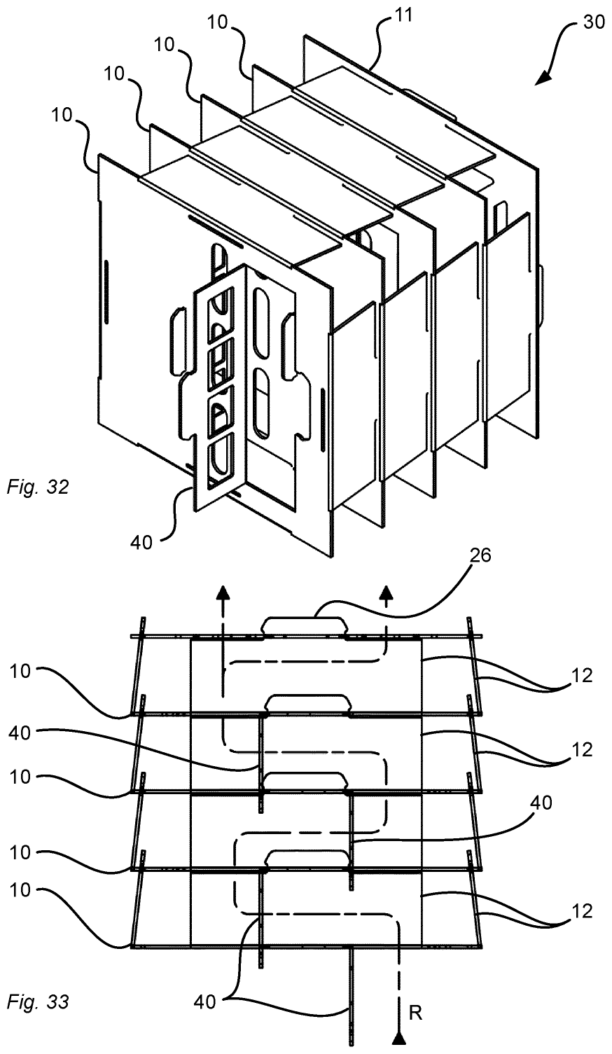

When the doors 40 are opened in the opposite direction to the direction of the flaps 12 (as shown in FIG. 29, FIG. 30 and FIG. 31), the effective length of the flaps 12 of the first separation element 10 and the effective length of the door 40 of the second separation element 10 are the same for two separation elements 10 (first separation element 10, second separation element 10) which are to be connected to each other and are connected to each other in a usable state. This clearly applies to all pairs of separation elements 10 shown in FIG. 29, FIG. 30 and FIG. 31 (I, II: II, III: III, IV: IV, V and V, VI). When the doors are open in the direction of the flaps 12 (not shown), the ratios are different. In this case, the effective length of the flaps 12 and the effective length of the door 40 of one and the same separation element 10 are the same.

The illustration in FIG. 31 shows, similar to the illustration in FIG. 17, a snapshot of the connection of several separation elements 10 to one another, whereby different effective lengths of the flaps 12 and the doors 40 are used for. The sequence of the separation elements 10 corresponds to the exemplary sequence shown in FIG. 29 and FIG. 30.

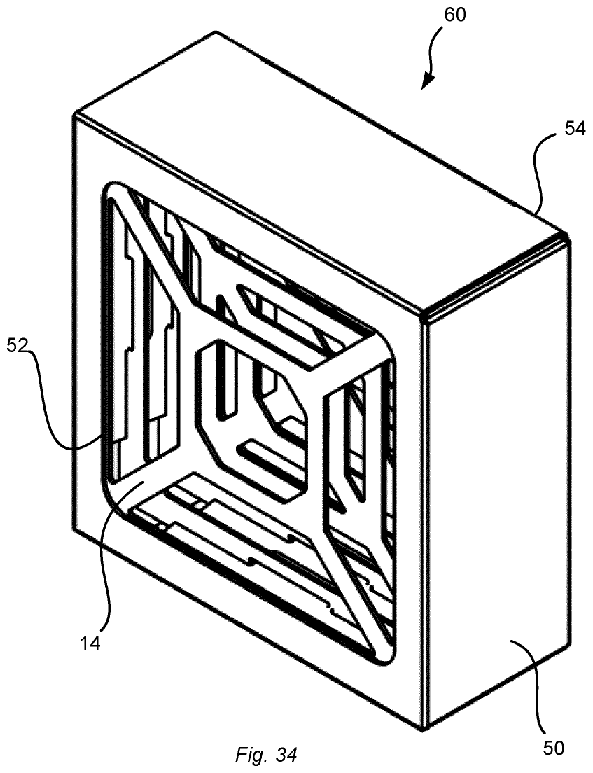

The illustration in FIG. 32 shows, similar to the illustrations in FIG. 15, FIG. 16 and FIG. 18, a separation combination 30. The separation combination 30 is a separation combination 30 formed with separation elements 10 each having at least one door 40. Exemplarily shown are separation elements 10 with flaps 12 without a subdivision into several sections and correspondingly separation elements 10 each having a door 40 also without such a subdivision into several sections. Of course, a separation combination 30 with separation elements 10 is also possible, in which the flaps 12 and the at least one door 40 are each subdivided into at least two sections (flap sections 22, 24: door sections 42, 44). A mixed configuration is also possible. In this case, the separation combination 30 comprises at least one separation element 10 with a subdivision of the flaps 12 and the at least one door 40 and also at least one separation element 10 without such a subdivision.

The illustration in FIG. 33 uses the dashed line with arrows at the ends to show the flow path of a raw gas flow R through a separation combination 30, in which the separation elements 10 surrounded by it each have at least one door 40. The illustration in FIG. 33 shows an example of the separation combination 30 according to FIG. 32 in a sectional side view.

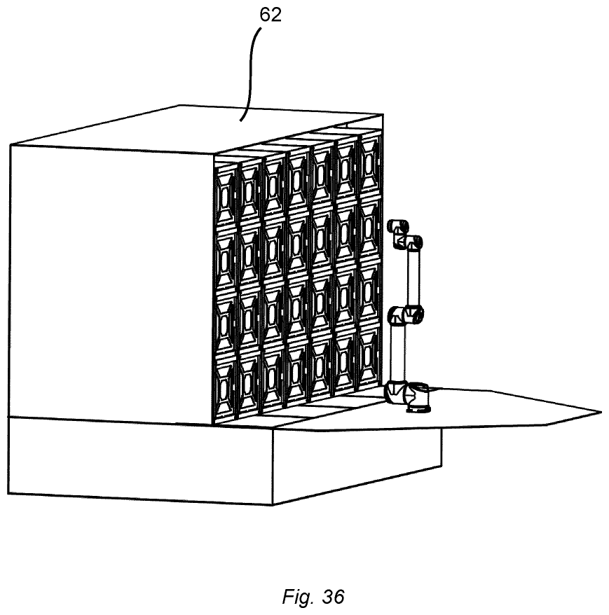

When used as intended, for example when used in a paint shop (FIG. 36), the separation combination 30 is flowed against by a raw gas flow R loaded with particles and the raw gas flow R flows through the separation combination 30, specifically at least through the open areas in the individual separation areas 14 resulting from the open doors 40. Due to the rotation of two separation elements 10 relative to each other (shown here as an example in the form of rotations of 180° relative to each other), an alternating sequence of the position of the doors 40 of the separation elements 10 lying one behind the other in the flow direction of the raw gas flow R results (in the explanation of the illustrations in FIG. 29 and FIG. 30, this alternating sequence of the position of the doors 40 was described as doors 40 located partly on the left and doors 40 located partly on the right).

Due to the alternating sequence of the position of the doors 40, the raw gas flow R is deflected several times within the separation combination 30. Downstream of an open door 40, the raw gas flow R meets the separation area 14, which optionally has no holes (hole-free) in the impingement area or has only a few and/or only small holes, of the separation element 10 located downstream (in the direction of the local flow) of the open door 40. The raw gas flow R undergoes a change of direction here and flows essentially along the separation area 14 (and limited by the separation area 14 of the upstream separation element 10) to the next open door 40. Here, the raw gas flow R passes through the door 40 and then meets the separation area of the separation element 10 located behind the open door 40 again, and so on. This multiple deflection leads to multiple changes in the direction of flow, resulting in a meandering course of the raw gas flow R through the separation combination 30.

In addition to a multiple change in the flow direction, this multiple deflection leads to the formation of vortices and/or local changes in the flow velocity and this improves the separation effect of an individual separation element 10 and the separation combination 30 as a whole. Separation then takes place primarily on the surface sections causing the change in flow direction, i.e. in particular the surfaces of the doors 40 hit by the raw gas flow and the respective surface areas of the separation areas 14 located behind an open door 40. Optionally, the separation elements 10 have holes 20 in their separation areas 14 as described above. This increases the vortex formation and leads to a further improved separation effect and the separation then also takes place at the edge lines and/or edge surfaces of the holes 20.

In the embodiment shown, the doors 40 are located in a fundamentally optional manner even in the flow path of the resulting raw gas flow R through the separation combination 30. The doors 40 are then structured for the purpose of allowing the raw gas flow R to pass through and have punched-out portions, holes or the like, collectively referred to below as holes 20. When the separation element 10 is used for separating particles carried along in a raw gas flow R, the holes 20 allow the inflowing raw gas flow R to pass through. The type and number of holes 20 and a surface structure resulting from the type and number of holes 20 and/or a hole pattern resulting from the type and number of holes 20 are not important and, accordingly, any surface structures or hole patterns are possible in principle and are to be regarded with this reference as being covered by the description presented here. This passage of the raw gas flow R through the doors 40, specifically through the holes 20 surrounded by the doors 40, also leads to an improvement in the separation effect. The separation then also takes place at the edge lines and/or edge surfaces of the holes 20 of the doors 40.

In the illustrations in FIG. 23 to FIG. 33, the door 40 of a separation element 10 and the connecting flaps 12 of the same separation element 10 are bent in different directions in relation to the plane of the respective separation area 14, i.e. the door 40 is bent towards an inflowing raw gas flow R (FIG. 33) and the connecting flaps 12 are bent away from the inflowing raw gas flow R. This is one possibility and this possibility has been shown in the figures due to the better overview and the better differentiability, especially in the side views, of the door 40 and the connecting flaps 12. Nevertheless, it should be emphasized that the door 40 (at least one door 40) and the connecting flaps 12 can also be bent in the same direction, i.e. all in the direction of an incoming raw gas flow R or all away from the incoming raw gas flow R.

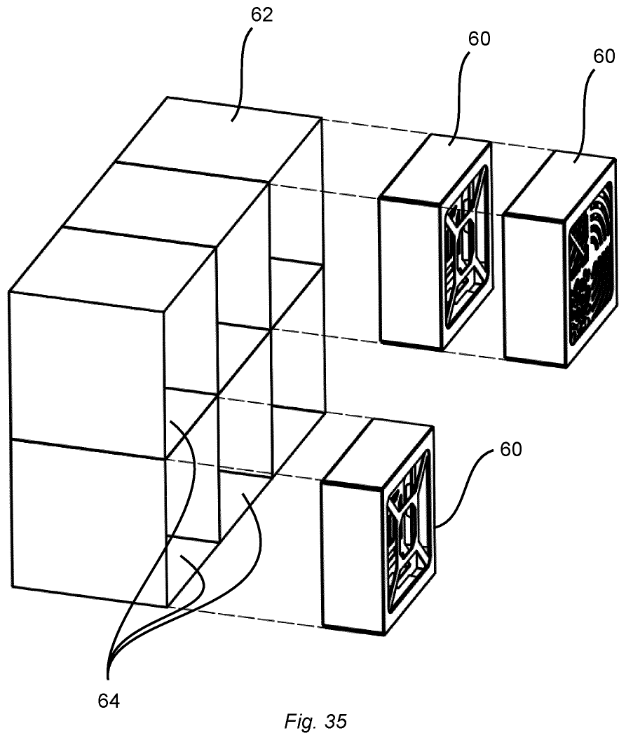

The illustration in FIG. 34 shows, on the one hand, a separation combination 30 according to FIG. 15, FIG. 16, FIG. 18 and FIG. 19 or according to FIG. 32 and, on the other hand, a frame 50 intended to receive the separation combination 30. The frame 50 has large openings in opposite side surfaces, which are marked as inflow opening 52 and outflow opening for differentiation and according to the respective function. For closing, the frame 50 has closing means 54, for example one or more closing flaps 54.

The frame 50 is, for example, a conventional or essentially conventional folding box (carton), apart from the inlet opening 52 and the outlet opening, i.e. a folding box which could otherwise also be used for packaging and/or shipping purposes. Suitable materials for the frame 50 include, for example, cardboard, paperboard (in particular solid cardboard or corrugated cardboard), plastic, metal (in particular pyrolysis-resistant metal) or the like.

The frame 50 receives the separation combination 30 in a form-fitting or at least essentially form-fitting manner. This means that the frame 50 is designed with respect to a respective separation combination 30 or a separation combination 30 and a number of separation elements 10 comprised thereby and connected to one another with respect to the frame 50 such that the interior of the frame 50 receives the separation combination 30 and the latter thereby extends to each inner surface of the frame 50 or at least essentially extends to each inner surface of the frame 50. In any case, a depth of the frame 50, measured from the inflow opening 52 to the outflow opening, corresponds (corresponds or corresponds at least essentially) to a thickness of a separation combination 30 intended to be received in the frame 50, measured starting from a first separation element 10 to the last separation element 10 (or final separation element 11) in the arrangement in staggered succession. In other words, a separation combination 30 placed in a frame 50 fills it: a separation combination 30 placed in a frame 50 completely or at least essentially completely occupies its internal volume. In the case of a separation combination 30 placed in a frame 50 according to FIG. 15, FIG. 16, FIG. 18 and FIG. 19 or according to FIG. 32 and the respective associated description, the first (front) separation element 10 is located directly behind the inlet opening 52 and the last (rear) separation element 10 is located directly in front of the outlet opening.

The illustration in FIG. 34 shows a separation combination 30 placed in a (closed) frame 50. Parts of the separation combination 30 placed in the frame 50 (the separation area 14 of its front separation element 10 is indicated) are visible through the inlet opening 52 in the frame 50.

A separation combination 30 placed in a frame 50 forms together with the frame 50 a separation apparatus (air flow separation apparatus) 60. Such a separation apparatus 60 or a plurality of such separation apparatuses 60 arranged one behind the other in a staggered manner (staggered one behind the other in the direction of a raw gas flow R) can be used in a manner known per se for separating particles carried along in a raw gas flow R, in particular paint particles, and is intended for separating particles carried along in a raw gas flow R.

A separation apparatus 60 comprises identical separation elements 10 or groups of identical separation elements 10. The possibility of using identical separation elements 10 to form a separation apparatus 60 supplements the advantage already mentioned above of the small space requirement of separation elements 10 in a flat state, because with identical separation elements 10 only one corresponding type of separation element 10 has to be delivered to a respective place of use.

The illustration in FIG. 35 shows a structural element 62, in particular a structural element 62 functioning as an extraction wall 62 of a painting system (see FIG. 36), with a plurality of compartments 64, wherein each compartment 64 is provided for receiving at least one separation apparatus 60. In the illustrations in FIG. 35 and FIG. 36, an upright extraction wall (an extraction wall with a vertically oriented inflow surface) is shown. It is also possible to use the structural element 62 in “horizontal” form, for example under a grating level of a painting system with a horizontally oriented flow surface.

The illustration in FIG. 35 shows, schematically simplified, a snapshot of the insertion of separation apparatuses 60 into the structural element 62 and the compartments 64 therein. By way of example, it is also shown that exactly one separation apparatus 60 or several separation apparatuses 60 can be inserted into a single compartment 64. The type and number of separation apparatuses 60 in the structural element 62 and the type and number of separation apparatuses 60 in each individual compartment 64 are determined by the respective application setting. The shape and the dimension of a separation apparatus 60 and of the or each separation element 10 comprised thereby are adapted to the shape and the dimension of an individual compartment 64. A compartment 64 or each compartment 64 may also be considered a receptacle or housing (separation housing) for a separation apparatus 60 (or a plurality of separation apparatuses 60). In this respect, the terms receptacle, compartment 64, and housing are synonymous.

The embodiment in FIG. 36 shows a structural element 62 according to FIG. 35 functioning, for example, as an extraction wall 62 of a painting system. At least one separation apparatus 60 of the type proposed here is located in each of the compartments 64 of the extraction wall 62 or at least individual compartments 64 of the extraction wall 62. With regard to the painting system, an industrial robot acting as a painting robot is shown as an example upstream of the extraction wall 62 (“upstream” in the direction of the raw gas flow R through the extraction wall 62 and the separation apparatuses 60 there). An object to be painted is not specifically shown. In principle, any objects, for example vehicle bodies, vehicle body parts, appliance housings, appliance housing parts, etc., can be painted by means of a painting system.

Individual aspects of the description provided here that are in the foreground can thus be briefly summarized as follows: Disclosed is a separation element (air flow separation element) 10 for separating particles carried along in a raw gas flow. The separation element 10 has a separation area 14 and connecting flaps 12 adjacent to the separation area 14 or extending from the separation area 14 for detachably connecting a separation element 10 to a further separation element 10. In addition, the separation element 10 has at least one door 40 and at least one door insertion area 48 in the separation area 14, wherein the door 40 has at least one door insertion section 46. In the case of interconnected separation elements 10, individually distinct separating surfaces (baffle surfaces) are produced in different planes. The separation area 14 of each separation element 10 is such a separating/impact surface. The different planes result from the distance between the respective separation areas 14 resulting when two separation elements 10 are connected to each other. Optionally, the distance between the separation areas 14 of two separation elements 10 connected to each other by means of the connecting flaps 12 can be adapted. To this effect, each connecting flap 12 is divided into at least two sections 22, 24 for the adaptation of its effective length and each section 22, 24 comprised by a respective connecting flap 12 has an insertion section 26 which can be inserted into an insertion area 18 of the further air flow separation element 10. Finally, a separation combination 30 (air flow separation combination) formed with such separation elements 10 and a separation apparatus (air flow separation apparatus) 60 comprising at least one separation combination 30 are disclosed. A separation apparatus 60 with separation elements 10 of the type proposed here can also be referred to as a separation module, because such a separation apparatus 60 can be modularly combined with at least one further separation apparatus 60, which also comprises separation elements 10 of the type proposed here, and/or with at least one separation apparatus already known in the prior art, for example a separation apparatus of the type mentioned at the beginning or the like.

### LIST OF REFERENCE NUMERALS

10 air flow separation element, separation element
11 separation element, end separation element
12 connecting means/flap (on the separation element)
14 separation area (of the separation element)
16 buckling point
18 insertion area/slot (in/on the separation area)
20 hole (in the separation area)
22 (first) section (of a flap/fastener)
24 (second) section (of a flap/fastener)
26 insertion section (on a flap/on a section of a flap)
30 air flow separation combination, separation combination
40 door
42 door section
44 door section
46 door insertion section (on a flap/door section)
48 door insertion area, door insertion slot
50 frame
52 opening, inlet opening
54 closing means, flap
60 air flow separation apparatus, separation apparatus/separation module
62 structural element/extraction wall
64 compartment/receptacle (in structural element/extraction wall)

1. An air flow separation element (10) for separating particles carried along in a raw gas flow, and
with a separation area (14) and insertion areas (18) as well as connecting flaps (12) adjoining the separation area (14) or extending from the separation area (14) for detachably connecting an air flow separation element (10) to another air flow separation element (10),
with at least one door (40) as well as at least one door insertion area (48) in the separation area (14),
wherein the door (40) has at least one door insertion section (46).

2. The air flow separation element (10) of claim 1,
wherein the door or each door (40) is divided into at least two door sections (42, 44) for the adaptation of an effective length of the respective door (40),
specifically a first door section (42) directly adjacent to the separation area (14) and a second door section (44) directly adjacent to the first door section (42),
wherein each door section (42, 44), each of which is comprised by a door (40), has a door insertion section (46) insertable into a door insertion area (48) of the other air flow separation element (10).

3. The air flow separation element (10) of claim 2,
wherein each connecting flap (12) is divided into at least two sections (22, 24) for the adaptation of an effective length of the respective connecting flap (12),
specifically a first section (22) directly adjacent to the separation area (14) and a second section (24) directly adjacent to the first section (22),
wherein each section (22, 24), each of which is comprised by a connecting flap (12), has an insertion section (26) insertable into an insertion area (18) of the other air flow separation element (10).

4. The air flow separation element (10) of claim 2,
with a buckling point (16) between two consecutive door sections (42, 44) of a door (40) and a door insertion section (46) originating in the area of the buckling point (16).

5. The air flow separation element (10) of claim 1,
with a rectangular separation area (14), in particular a square separation area (14),
wherein the air flow separation element (10) is connectable to another air flow separation element (10) in at least two different orientations.

6. An air flow separation combination (30) with a plurality of air flow separation elements (10) according to claim 1 connected to each other and arranged in staggered succession.

7. The air flow separation combination (30) of claim 6,
with an alternating sequence of a position of the doors (40).

8. An air flow separation apparatus (60) for separating particles carried along in a raw gas flow
comprising an air flow separation combination (30) of claim 6 received by a frame (50).

9. A painting system with a structural element (62) and a plurality of air flow separator apparatuses (60) according to claim 8, placed in receiving compartments (64) of the structural element (62).

10. A use of an air flow separation element (10) of claim 1 for separating particles carried along in a raw gas flow.

11. A method of separating paint particles carried along in a raw gas flow, wherein the raw gas flow is passed through at least one air flow separation element according to claim 1.

12. The air flow separation element (10) of claim 3,
with a buckling point (16) between two consecutive sections (22, 24) of a connecting flap (12) and an insertion section (26) originating in the area of the buckling point (16).

13. A use of an air flow separation combination (30) of claim 6 for separating particles carried along in a raw gas flow.

14. A use of an air flow separation apparatus (60) of claim 8 for separating particles carried along in a raw gas flow.

15. A use of a painting system of claim 9 for separating particles carried along in a raw gas flow.

16. A method of separating paint particles carried along in a raw gas flow, wherein the raw gas flow is passed through at least one air flow separation combination according to claim 6.

17. A method of separating paint particles carried along in a raw gas flow, wherein the raw gas flow is passed at least one air flow separation apparatus according to claim 8.
